(19) United States
(12) Patent Application Publication
(10) Pub. No.: US 2026/0203287 A1
(43) Pub. Date: Jul. 16, 2026

(54) Systems and Methods for Generative Creation of an Autonomous Agent In a Database System

(71) Applicant: Salesforce, Inc., San Francisco, CA (US)

(72) Inventors: Prithvi Krishnan PADMANABHAN, San Ramon, CA (US); Avanthika RAMESH, San Francisco, CA (US)

(21) Appl. No.: 19/238,891

(22) Filed: Jun. 16, 2025

Related U.S. Application Data
(60) Provisional application No. 63/744,156, filed on Jan. 10, 2025.

(51) Int. Cl. G06F 16/2453; G06F 16/22; G06F 16/23

(52) U.S. Cl. CPC G06F 16/24542; G06F 16/22; G06F 16/2379

(57) ABSTRACT

A computing services environment may include an agent creator configured to determine a plurality of metadata entries by analyzing flowchart description information via a generative language model. The computing services environment may also include a database system storing autonomous agent definition information defining an autonomous agent and referencing the plurality of metadata entries. The computing services environment may also include an orchestration engine configured to instantiate an instance of the autonomous agent based on the autonomous agent definition information. The computing services environment may also include an agent platform configured to execute the plurality of actions including retrieving data via the data retrieval action and updating information stored in the database system.

### CROSS-REFERENCE TO RELATED APPLICATIONS

This application claims the benefit under 35 U.S.C. § 119(e) of U.S. Provisional Patent Application 63/744,156 (Attorney Docket No. SFDCP252P) by Padmanabhan, titled: “Systems and Methods for Generative Creation of an Autonomous Agent In A Database System”, filed on Jan. 10, 2025, which is incorporated herein by reference in its entirety for all purposes.

### FIELD OF TECHNOLOGY

This patent application relates generally to database systems, and more specifically to autonomous artificial intelligence agents implemented in the context of database systems.

### BACKGROUND

Autonomous artificial intelligence agents take advantage of recent advances in large language models to generate novel text, interact with people, and perform various types of operations with minimal or no oversight. Autonomous artificial intelligence agents typically rely on one or more standard large language models. Such models are typically not tuned for a particular purpose, but rather are used in a variety of applications. Like humans, however, large language models are capable of a wide range of behaviors, whereas a provider of an autonomous artificial intelligence agent would generally prefer that the agent behave in particular ways.

Creating an autonomous artificial intelligence agent using conventional techniques involves manually crafting prompts and natural language instructions. Even after such a manual process, the autonomous artificial intelligence agent will be imperfectly adapted to its intended purpose. For instance, different people may configure an autonomous artificial intelligence agent in very different ways, leading to different performance in different situations. Accordingly, improved techniques for the configuration of autonomous artificial intelligence agents are desired.

### BRIEF DESCRIPTION OF THE DRAWINGS

The included drawings are for illustrative purposes and serve only to provide examples of possible structures and operations for the disclosed inventive systems, apparatus, methods, and computer program products for generative creation of artificial intelligence agents in a database system. These drawings in no way limit any changes in form and detail that may be made by one skilled in the art without departing from the spirit and scope of the disclosed implementations.

FIG. 1 illustrates an autonomous artificial intelligence agent creation overview method, performed in accordance with one or more embodiments.

FIG. 2 illustrates various elements that may be included within a computing services environment, configured in accordance with one or more embodiments.

FIG. 3 illustrates a method for creating an autonomous agent, performed in accordance with one or more embodiments.

FIG. 4 illustrates a method of creating one or more metadata entries for a flowchart node, performed in accordance with one or more embodiments.

FIG. 5 illustrates an example of flowchart input information, which may be provided as input in accordance with one or more embodiments.

FIG. 6 illustrates a computing services environment, configured in accordance with one or more embodiments.

FIG. 7 illustrates a method providing an overview of the lifecycle of an autonomous agent, performed in accordance with one or more embodiments.

FIG. 8 illustrates a trust model for the autonomous agent platform, configured in accordance with one or more embodiments.

FIG. 9 illustrates an architecture diagram of elements of the computing services environment, configured in accordance with one or more embodiments.

FIG. 10 shows a block diagram of an example of an environment that includes an on-demand database service configured in accordance with some implementations.

FIG. 11A shows a system diagram of an example of architectural components of an on-demand database service environment, configured in accordance with some implementations.

FIG. 11B shows a system diagram further illustrating an example of architectural components of an on-demand database service environment, in accordance with some implementations.

FIG. 12 illustrates one example of a computing device, configured in accordance with one or more embodiments.

FIG. 13 illustrates a method for processing multimodal input to an agent, configured in accordance with one or more embodiments.

FIG. 14 illustrates an overview method for configuring real-time augmented generation (RAG) for autonomous agents, performed in accordance with one or more embodiments.

FIG. 15A illustrates a portion of an autonomous agent data retriever data model, configured in accordance with one or more embodiments.

FIG. 15B illustrates a data model diagram for providing access to unstructured data, configured in accordance with one or more embodiments.

FIG. 16 illustrates an architecture diagram for supporting RAG within an autonomous agent, configured in accordance with one or more embodiments.

FIG. 17 illustrates a process flow for configuring unstructured data, arranged in accordance with one or more embodiments.

FIG. 18 illustrates an architecture for configuring unstructured data, arranged in accordance with one or more embodiments.

FIG. 19 illustrates a method for retrieval augmented generation at runtime, performed in accordance with one or more embodiments.

FIG. 20 illustrates a method of retrieving information at a conversational chat assistant, performed in accordance with one or more embodiments

FIG. 21 illustrates an architecture configuration supporting runtime retrieval augmented generation, provided in accordance with one or more embodiments.

FIG. 22 illustrates an example of flowchart input information, which may be provided as input in accordance with one or more embodiments

FIGS. 23-26 illustrate user interfaces generated in accordance with one or more embodiments.

### DETAILED DESCRIPTION

### Introduction

Techniques and mechanisms described herein provide for the autonomous creation of an autonomous agent within a computing services environment based on visual input including a flowchart. The system can perform multimodal analysis of the flowchart to identify textual information characterizing nodes in the flowchart as well as linkages between the nodes. The system may identify and/or create action definition metadata entries corresponding to those nodes and store an autonomous agent definition references those action definition metadata entries. The action definition metadata entries may include, for instance, a newly created data retriever configured to retrieve data from inside and/or outside the computing services environment. Subsequently, an instance of an autonomous agent may be instantiated and executed based on the autonomous agent definition. Executing the instance of the autonomous agent definition may include operations such as selecting actions to perform based on the action definitions, retrieving information via the data retriever, and updating information stored in a database system.

According to various embodiments, techniques and mechanisms described herein provide for the automated creation of data retrievers to retrieve information to process via an autonomous agent. For example, a flowchart may reference the retrieval of “orders” or the analysis of “opportunities.” In such a situation, the autonomous creation process for the autonomous agent may determine that the terms “orders” and “opportunities” refers to particular database object types corresponding to database objects stored in the database system, and then configure a data retriever for retrieving the subset of such database objects needed by the autonomous agent. As another example, a flowchart may reference an external data source such as LinkedIn or Google Drive. In such a situation, the autonomous creation process for the autonomous agent may identify the external data source, an API for accessing the external data source, connection information for accessing the external data source, query information for retrieving data from the external data source, and/or other such information. Such information may then be used to configure or create a data connector for retrieving the information.

In some embodiments, the information identified to create the data retrievers may be determined by a generative language model. For instance, an input prompt may include flowchart description information produced by analyzing flowchart input information via multi-modal analysis. The input prompt may also include natural language instructions to identify any data retrievers needed for the flowchart as well as any information needed to configure and create the data retrievers.

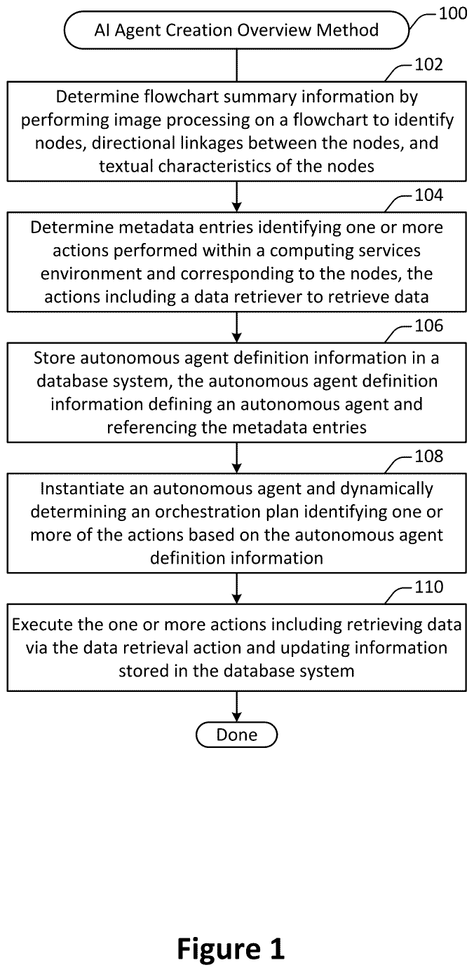

FIG. 1 illustrates an autonomous artificial intelligence agent creation overview method 100, performed in accordance with one or more embodiments. According to various embodiments, the various operations shown in FIG. 1 may be performed in the course of configuring, instantiating, and executing an autonomous artificial intelligence agent (referred to herein as an autonomous agent). The method 100 may be performed at a computing services environment.

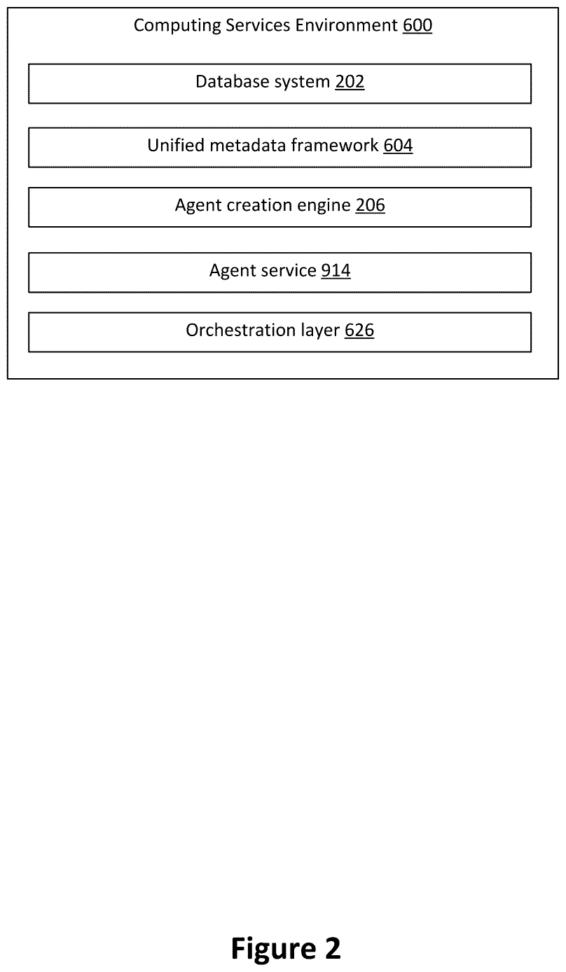

The method 100 is described partially in reference to FIG. 2, which illustrates various elements that may be included within a computing services environment 600. The computing services environment 600 includes a database system 202, a unified metadata framework 604, an agent creation engine 206, an agent service 914, and an orchestration layer 626.

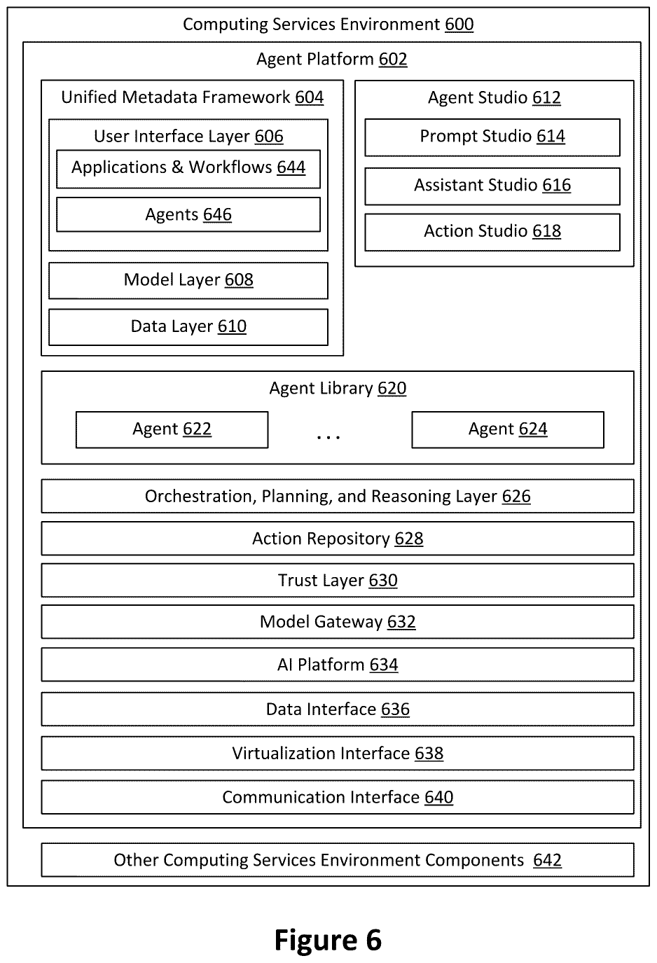

Computing services environments are typically quite complex and include many components working in concert. Although not all of those components are described in this application so as not to obscure the various concepts, additional details regarding various other components that may be included within the computing services environment 600 are shown in FIG. 6, and particularly those components pertinent to the configuration, provisioning, instantiation, and execution of autonomous agents.

Flowchart description information is determined at 102 by performing image processing on a flowchart to identify nodes represented in the flowchart. According to various embodiments, the flowchart description information may be performed by the agent creation engine 206. Performing the image processing may involve evaluating the image via a multi-modal AI model configured to process visual data as well as identify and analyze textual information included in an image.

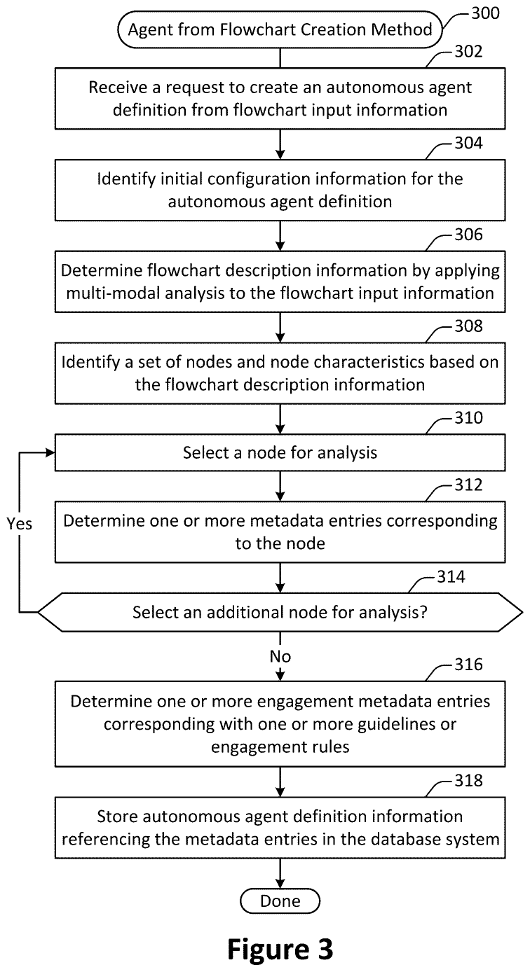

In some implementations, the flowchart may provide a visual representation of a set of directionally connected actions that may be performed within computing services environment. The flowchart description information may be provided in natural language. The flowchart description information may also include directional linkages between the nodes and textual characteristics of the nodes. Additional details regarding the determination of the flowchart description information are discussed with respect to the method 300 shown in FIG. 3.

Metadata entries identifying one or more actions performed within a computing services environment and corresponding to the nodes are determined at 104. One or more of the actions may include retrieving data for use by an autonomous agent configured to perform the operations shown in the flowchart. Autonomous agent definition information is stored in a database system at 106. For instance, the autonomous agent definition information may be stored in the database system 202 shown in FIG. 2. The autonomous agent definition information may define an autonomous agent and reference the metadata entries.

According to various embodiments, the metadata entries may be stored in accordance with the unified metadata framework 604. The unified metadata framework 604 may provide a structure for defining resources used to create agents. Various types of resources may be included in an autonomous agent definition. For example, prompt templates may be used to create prompts to provide to generative language models. As another example, action definitions may support the selection and performance of actions such as retrieving data, storing data, generating text, and/or other types of actions executable within the computing services environment. As yet another example, orchestration information may be used to select and implement orchestration plans for selecting actions appropriate to a particular situation being handled by an instance of the autonomous agent.

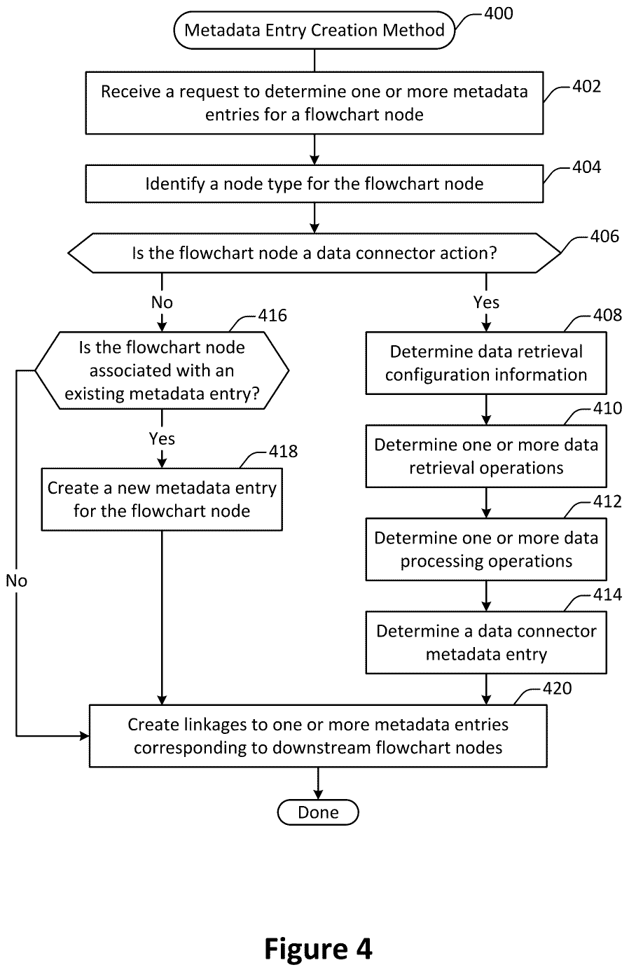

In some implementations, the metadata entries may facilitate linking the actions performed within the computing services environment with an autonomous agent definition. In this way, the actions may be selected and executed during the execution of an autonomous agent instantiated based on the autonomous agent definition. Additional details regarding the determination and storage of the metadata entries and the autonomous agent definition information are discussed with respect to the method 400 shown in FIG. 4.

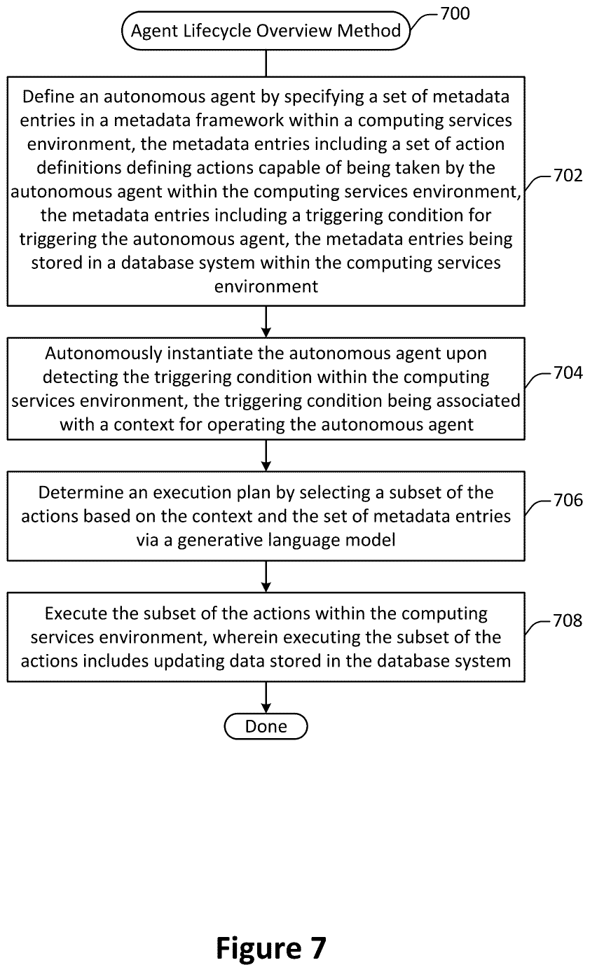

An instance of the autonomous agent is instantiated at 108 based on the autonomous agent definition. In some embodiments, the autonomous agent instance may be instantiated via the agent service 914 shown in FIG. 2. Instantiating the autonomous agent may involve one or more operations related to provisioning the autonomous agent instance, determining an initial context for the autonomous agent instance, and the like. Additional details regarding such instantiation are discussed with respect to the method 700 shown in FIG. 7.

Once the autonomous agent is instantiated, an orchestration plan may be determined based on actions identified in novel planning text generated by a generative language model based on the autonomous agent definition. According to various embodiments, the orchestration plan may be determined by the orchestration layer 626 shown in FIG. 2. The one or more actions are executed at 110 by the computing services environment 600. Executing the one or more actions may involve operations such as updating information stored in the database system and retrieving data via the data retrieval action.

In some implementations, one or more of the actions included in the orchestration plan may be selected from actions included in the autonomous agent definition. Such actions may be identified and/or created as discussed with respect to the operations 102 through 106. However, not all actions included in the autonomous agent definition need be performed by any particular autonomous agent instance. Further, actions selected for performance may include actions other than those created via the creation process. For instance, one or more default or standard options available via the computing services environment may be selected for performance.

### Systems and Processes for Autonomous Agent Creation from a Flowchart

In some embodiments, an autonomous agent may be created from a flowchart. The flowchart may be provided as one or more images and/or may be provided in some other format. For instance, the flowchart may be provided in a markup language used to define a flowchart. An autonomous agent and/or another AI model may determine a description of the flowchart by processing it as multi-modal input. The description may then be used to determine metadata entries for defining the agent.

FIG. 3 illustrates a method 300 for creating an agent from a flowchart, performed in accordance with one or more embodiments. According to various embodiments, the method 300 may be performed at a computing services environment such as the computing services environment 200 shown in FIG. 2.

A request to create an autonomous agent definition from flowchart input information is received at 302. In some embodiments, the request and the flowchart input information may be provided via a chat interface. For instance, the flowchart may be provided in the course of conducting a conversation between a user and an autonomous agent embodied as a conversational chat assistant.

In some embodiments, the request may be received via an application procedure interface. Alternatively, the request to create the autonomous agent definition may be provided in the context of a graphical user interface such as an autonomous agent creation wizard. In such a situation, the flowchart input information may be uploaded as one or more files. For instance, the flowchart may be provided via an upload dialog in the course of accessing the autonomous agent creation wizard.

In some embodiments, the flowchart input information may include one or more images. Alternatively, the flowchart input information may be provided in a different format, such as a Visio diagram or a Lucidchart. In some configurations, the flowchart input information may include textual information such as metadata, markup language characterizing nodes and/or linkages, and/or a textual description of the flowchart or portions of the flowchart.

Initial configuration information for the agent is identified at 304. According to various embodiments, the initial configuration information may include details such as the agent's name, agent type, description, creation date, and the like. Some such information may be determined based on user input, while other such information may be determined automatically by the system itself. For instance, the initial configuration information may the autonomous agent definition as being associated with an entity accessing services via the computing services environment. The entity may be identified on the basis of the request to create the autonomous agent being received from a client machine authenticated to a database account associated with the entity.

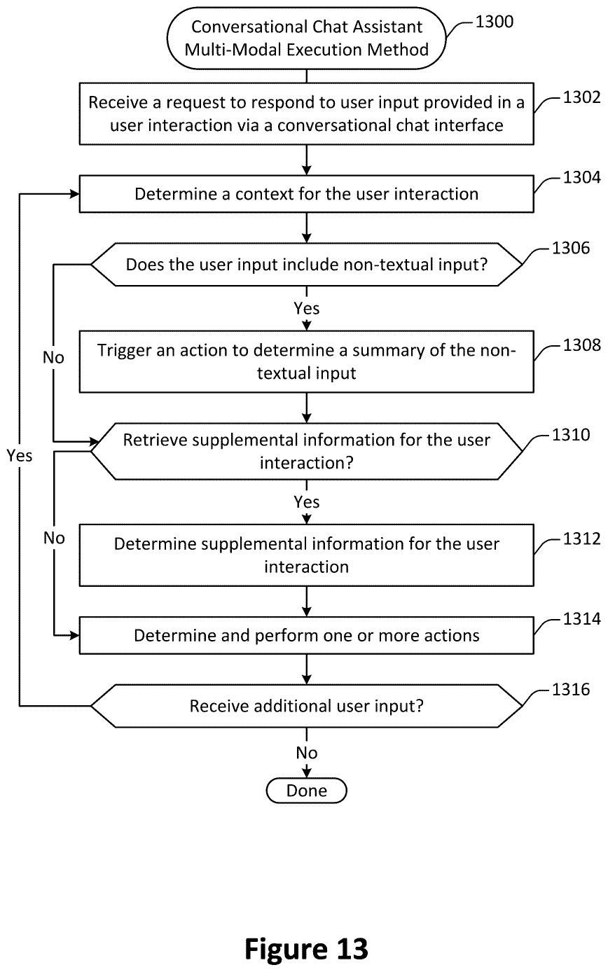

Flowchart description information is determined at 306 by applying multi-modal analysis to the flowchart input information. According to various embodiments, the flowchart description information may include elements such as natural language and/or markup language description of various nodes in the flowchart, linkages between the nodes, guidelines or rules, triggering conditions, legend information, and/or other information included in the flowchart. An example of the types of operations that may be performed when for evaluating multi-modal input to produce a description of flowchart information is described with respect to the method 1300 shown in FIG. 13.

In some embodiments, a flowchart node may correspond to an action in which an autonomous agent interacts with a user, for instance via a chatbot interface. For example, a flowchart node may be associated with an action such as requesting user input, informing the user of an outcome, responding to a user inquiry, and/or other such user interactions.

In some embodiments, a flowchart node may correspond to an action taken within the computing services environment. For example, a flowchart node may be associated with an action such as retrieving data from the database system, storing data to the database system, triggering a workflow, sending an internal message, processing retrieved data, and/or other such operations.

In some embodiments, a flowchart node may correspond to an action taken outside of the computing services environment, for instance via a communication interface. For example, a flowchart node may correspond to an action such as booking an appointment, posting information to a social network, performing an operation on a blockchain, transmitting an email or other external message, and/or taking any other such action.

In some embodiments, the flowchart description information may identify linkages between nodes. Linkages may be directional in the sense that one action is performed after another action is completed. In some configurations, linkages may be conditional. For example, upon performing an action associated with one flowchart node, a first downstream action may be triggered if a condition is true and a second downstream action may be triggered if the condition is false.

In some embodiments, the flowchart description information may identify one or more guidelines or rules. A guideline or rule may govern the operation of the autonomous agent as a whole or may be specific to particular action. For example, a guideline or rule may specify a restriction on a length of time or other type of user input to be processed by the autonomous agent. As another example, a guideline or rule may prohibit the autonomous agent from deviating from a set of permitted actions.

In some embodiments, the flowchart input information may include one or more triggering conditions for triggering an autonomous agent defined based on the flowchart. For instance, the flowchart input information may include a flowchart node or metadata specifying that an autonomous agent instance is to be instantiated based on the autonomous agent definition upon detection of natural language user input provided via chatbot interface and meeting one or more criteria.

In some embodiments, the flowchart input information may include a legend characterizing other elements of the flowchart input information. For instance, the legend may use text, color, and/or other indicators to identify which portions of a flowchart image or other flowchart input information correspond to elements such as agent actions, user interactions, user input, utterances, instructions, guardrails, rules, and the like.

According to various embodiments, because the flowchart input information can be dynamically and autonomously processed as multimodal input, the flowchart input information need not be provided in a predetermined format. For example, one set of flowchart input information may employ a legend that uses color to identify different portions of a flowchart image, while another set of flowchart input information may employ a legend that uses dashed lines for that purpose. As another example, the system may seamlessly process different flowcharts provided in different formats.

A set of nodes and node characteristics are identified at 308 based on the flowchart description information. In some embodiments, such information may be identified by parsing the flowchart description information, which may include novel natural language text generated by a generative language model. For instance, the flowchart description information may be provided in JSON or another suitable markup language.

A node is selected for analysis at 310. In some embodiments, nodes may be selected from the identified nodes in any suitable order, in sequence or in parallel. For instance, nodes may be selected in an order depending on linkages between the nodes, such that nodes selected for analysis only lead to nodes that have already been analyzed and hence are already associated with metadata definitions.

One or more metadata entries corresponding to the selected node are determined at 312. According to various embodiments, determining the one or more metadata entries may involve operations such as determining a node type, identifying an existing action metadata entry corresponding to the node, and/or configuring a new action metadata entry for the node. Additional details regarding the determination of the one or more metadata entries are discussed with respect to the method 400 shown in FIG. 4.

A determination is made at 314 as to whether to select an additional node for analysis. According to various embodiments, additional nodes may continue to be selected until all available nodes identified in the flowchart description information have been processed.

One or more engagement rule metadata entries corresponding with one or more guidelines or engagement rules are determined at 316. In some embodiments, a metadata entry corresponding to one or more guidelines or engagement rules may be determined based on user input. For instance, a user may identify one or more guidelines or engagement rules via graphical user interface or a chatbot.

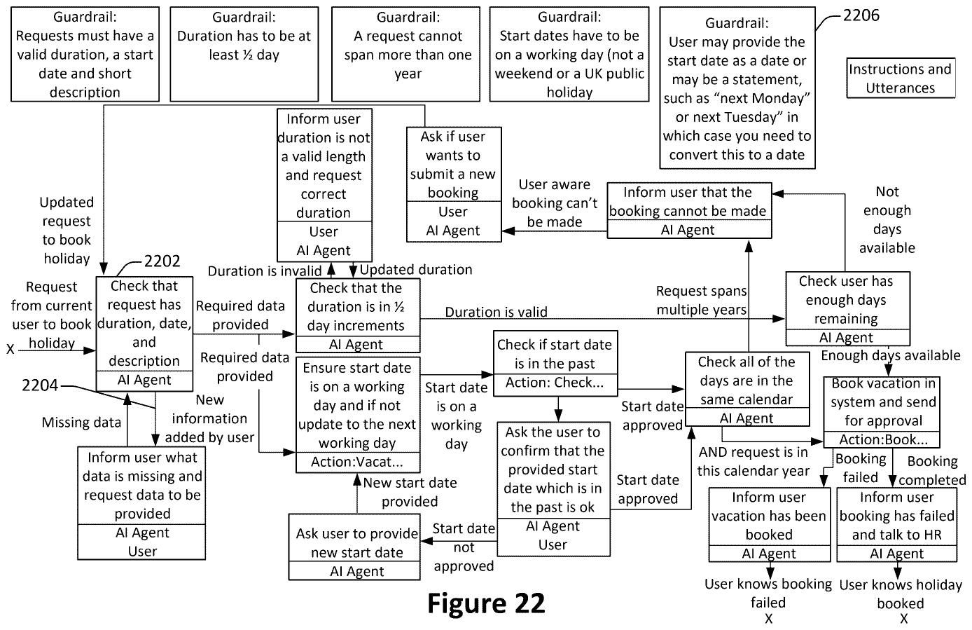

In some embodiments, a metadata entry corresponding to one or more guidelines or engagement rules may be determined by identifying information from the flowchart that does not correspond with nodes or edges. For instance, in FIG. 22, the guardrail box 2206 identifies supporting information for the autonomous agent, which may be configured into instructions included in a prompt associated with the autonomous agent.

Autonomous agent definition information referencing the metadata entries is stored in the database system at 318. According to various embodiments, the autonomous agent definition information may include some or all of the initial configuration information identified at 304, as well as other information suitable for instantiating an autonomous agent instance. For instance, the autonomous agent definition information may specify information such as an agent name, a planner framework, an entity or database account with which the autonomous agent definition is associated, and the like.

In some embodiments, one or more of the operations shown in FIG. 3 may be performed by an LLM. An example of a prompt instructing an LLM to produce one or more metadata entries is as follows:
You are an AI assistant that automates generates topics and description based on the flowchart.
Your goal is to identify the right set of instructions based on the flowchart such that LLMs can comply with those instructions for those topics
You are also provided list of metadata, actions and datasources that you can use in order to identify based on the flowchart
   {{metadata}}
   {{datasources}}
   {{actions}}
Response:
Your job is provide the Job spec (Jobs to be done) based on the role. Do not add any pre or post information in the output. Just show the jobs to be done. If company information such as name and website is provided, use that to generate more personalized output. As an {! $Input:AgentDetail_c.Role_c} working at {! $Input:AgentDetail_c.CompanyName_c} in their {! $Input:AgentDetail_c.Domain_c} with website information {! $Input:AgentDetail_c.CompanyWebsite_c}. Use the website as well industry domain and also salesforce canonical model for that industry to generate jobs to be done. The jobs to be done of your job that will help in creating automating and assisting agents. Keep it concise without missing any information. Each job title should be just within 50 characters with a description describing the job. For the job title do not use any special characters, you can use _ or spaces

An example of one or more metadata entries created in accordance with FIG. 3 are as follows:

```
JSON Metadata
{
  “AI_Agent_Description”: “You are an AI Agent whose job is to help
  Booking
  Agents manage holiday requests efficiently and ensure all criteria
  are met
  before confirming a booking.”,
  “Sample_Utterances”: [
    “I would like to book a holiday starting next Monday for 10
    days.”,
    “Can you check if I have enough days remaining for my holiday
    request?”
    “Please inform me if my holiday booking has been completed.”,
    “What data is missing from my holiday request?”,
    “Is the provided start date for my holiday on a working day?”],
  “Topics”: [
    {
    “Topic”: “Holiday Booking”,
    “ClassificationDescription”: “This topic covers the process of
    booking a
    holiday, ensuring all criteria are met, and handling any issues
    that arise.”,
    “Scope”: “The job-to-be-done includes validating holiday
    requests, checking
    for sufficient days, and confirming or denying the booking
    based on various
    conditions.”,
  “Instructions”: [
    “Step 1: Check that request has duration, date, and
    description.”,
    “Step 2: Check that the duration is in ½ day increments.”,
    “Step 3: Inform user duration is not a valid length and request
    correct
    duration when duration is invalid.”,
    “Step 4: Ensure start date is on a working day and if not, update
    to the next
    working day.”,
    “Step 5: Check if start date is in the past when start date is on
    a working
    day.”,
    “Step 6: Ask the user to confirm that the provided start date
    which is in the
    past is ok when start date is in the past.”,
    “Step 7: Check all of the days are in the same calendar.”,
    “Step 8: Check that user has enough days remaining.”,
    “Step 9: Book vacation in system and send for approval when
    enough days
    available.”,
    “Step 10: Inform user vacation has been booked when booking
    is
    completed.”,
    “Step 11: Inform user booking has failed and to talk to HR when
    booking
    failed.”,
    “Step 12: Inform user what data is missing and request data to
    be provided
    when missing data.”,
    “Step 13: Ask user to provide new start date when new start
    date provided.”,
    “Step 14: Ask if user wants to submit a new booking when user
    aware
    booking can't be made.”,
    “Step 15: Inform user that the booking cannot be made when
    user wants to
    submit a new booking.”]
  }
}
```

FIG. 4 illustrates a method 400 for creating one or more metadata entries for a flowchart node. According to various embodiments, the method 400 may be performed in the computing services environment 200 shown in FIG. 2.

A request to determine one or more metadata entries for a flowchart node is received at 402. In some embodiments, the request may be generated as discussed with respect to the operation 312 shown in FIG. 3.

A node type for the flowchart node is identified at 404. In some embodiments, the node type may be identified based on legend information included in the flowchart description information. Alternatively, the node type may be identified based on information describing the flowchart node. For instance, if the flowchart node is associated with textual information describing an action being performed, data being retrieved, or other such operations, the node type may be identified based on that descriptive information.

A determination is made at 406 as to whether the flowchart node is a data connector action. In some embodiments, the determination may be made based on the node type identified at 404.

Upon determining that the flowchart node is a data connector action, data retrieval configuration information is determined at 408. In some embodiments, the data retrieval configuration information may identify a source from which to retrieve data. For example, descriptive text associated with the flowchart node may identify the data source as LinkedIn, Google Drive, an internal database table, an external web search, or another data source.

In some embodiments, the data retrieval configuration information may identify one or more authentication or connection parameters for accessing the source. For example, the request to create the autonomous agent definition may be received from a client machine authenticated to a user account. The user account may be associated with credentials, such as a login, password, OAuth token, or other such information corresponding to the identified data source. Alternatively, or additionally, the client machine may be interactively queried to identify one or more authentication or connection parameters, for instance via natural language transmitted via a chatbot. As still another possibility, such information may be extracted from text included in the flowchart description information, such as metadata included with a flowchart image or text included on the flowchart image.

In some embodiments, the one or more data retrieval operations may identify one or more parameters for retrieving data from the identified data source. For example, a data retrieval parameter may include a file name, a file type, an API parameter, a search parameter, a filter parameter, and/or other such input. As another example, for instance in the context of retrieving information from the database system, the parameters may include information such as a database object type to retrieve, one or more selection parameters for selecting one or more data objects, and/or one or more filter parameters for filtering information that has been retrieved. Such operations may be identified from the flowchart description information or interactively identified based on communication with the client machine.

One or more data processing operations are optionally determined at 412. In some embodiments, the one or more data processing operations may include any pre-processing operations performed on data retrieved via the data connector. For example, data may be extracted from a file, filtered via one or more filter conditions, summarized, or otherwise analyzed. Such operations may be identified from the flowchart description information or interactively identified based on communication with the client machine. As another example, data may be stored to a designated location within the computing services environment, such as the database system or another data repository.

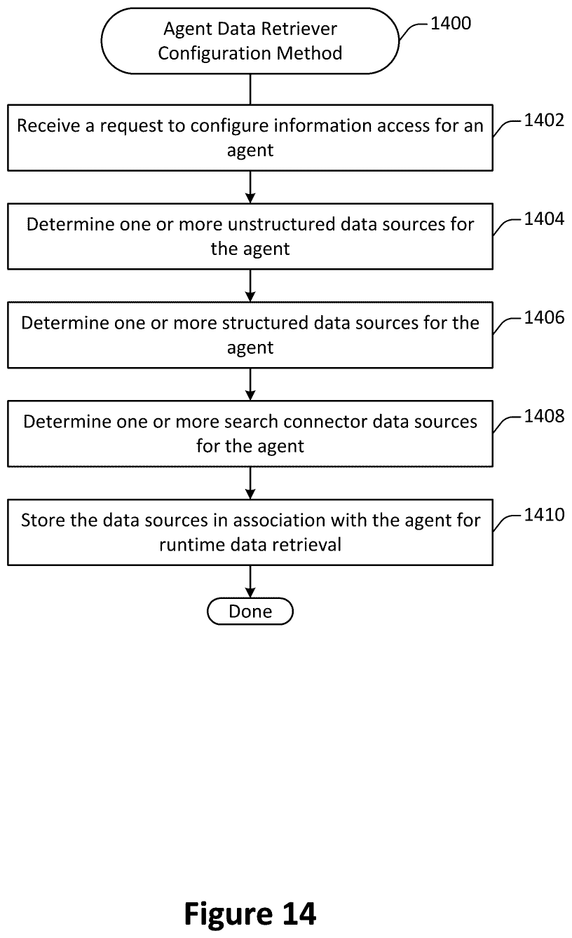

A data connector metadata entry is determined at 414. In some embodiments, an existing data connector metadata entry may be selected and referenced in association with configuration information, data retrieval operations, and/or data processing operations. For example, the computing services environment may be preconfigured with a data connector for use in retrieving information from Google Drive or another external source. As another example, the computing services environment may be associated with one or more preconfigured internal connectors for accessing information stored inside the computing services environment, such as a database connector for accessing information stored in the database system. Additional details regarding the creation of data connectors (also referred to herein as data retrievers) are discussed with respect to FIG. 14 through FIG. 22.

In some implementations, a new data connector metadata entry may be created. For instance, a new data connector metadata entry may be created to retrieve data from an external data source that is not already associated with a preconfigured connector within the computing services environment.

Upon determining instead that the flowchart node is not a data connector action, then at 416 a determination is made as to whether the flowchart node is associated with an existing metadata entry. In some embodiments, the determination may be made at 416 by searching a repository of metadata actions using information extracted from the flowchart description information.

Upon determining that the flowchart node is not associated with an existing metadata entry, then a new metadata entry for the flowchart node is created at 418. According to various embodiments, the new metadata entry may specify information such as a description of the action to be performed, one or more inputs for the action to be performed, one or more outputs for the action to be performed, and the like. For example, an action may be created to perform an operation such as checking to see if a date is in the past, booking an event via an external service, analyzing retrieved information to make a particular determination, or other such operations. Creating the action may involve, for instance, determining an input prompt to be completed by a generative language model.

Linkages to one or more metadata entries corresponding to downstream flowchart nodes are created at 420. In some embodiments, such a linkage may be identified by analyzing the flowchart description information. The linkage may then be created by including an identifier identifying a metadata entry associated with the downstream node in the agent definition. For instance, the identifier may be added to a planner framework that specifies a set of actions to perform and identifies ordering and other dependency relationships among the actions.

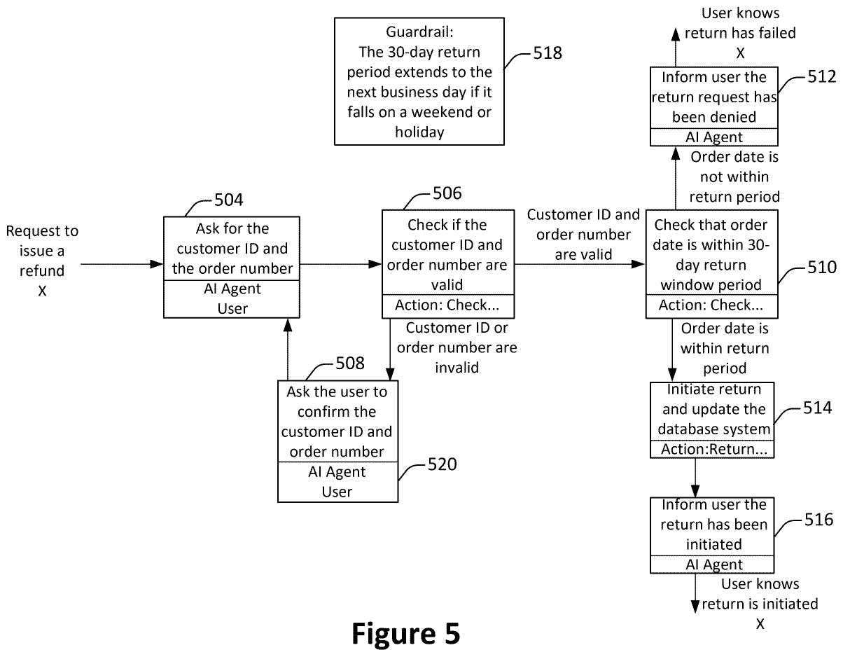

FIG. 5 illustrates an example of flowchart input information 500, which may be provided as input in accordance with one or more embodiments. Because it is included in a patent application, FIG. 5 has been formalized to comply with USPTO requirements. However, in some embodiments, the system described herein may receive as input an image of a flowchart that is not formalized or constructed in a standardized or predetermined manner. Alternatively, or additionally, the system may receive as input a flowchart formatted according to other specifications such as a markup language. Further, the system may accept multiple flowcharts, for instance flowcharts that are configured to work in concert.

The flowchart represented in FIG. 5 illustrates a workflow for processing a request to issue a refund. Such a flowchart may be used as input to autonomously determine autonomous agent definition information that may be used to instantiate an autonomous agent capable of responding to such a request via a conversational chat interface. The flowchart represented in FIG. 5 is only an example of the types of flowcharts that may be analyzed and used to create such an autonomous agent. According to various embodiments, flowchart input information may be used to identify any of various types of actions capable of being performed by a computing services environment.

In FIG. 5, a request to issue a refund is received at 502. At 504, the autonomous agent is instructed to ask the user for the customer ID and the order number. At 506, the autonomous agent is instructed to check that the customer ID and order number are valid. At 508, the autonomous agent is instructed to ask the user to confirm the customer ID and order number if either is invalid. At 510, the autonomous agent is instructed to check that the order data is within a 30-day return window period. At 512, the autonomous agent is instructed to inform the user that the request has been denied of the order data is not within the return period. At 514, the autonomous agent is instructed to initiate the return and update the database system if the order data is within the return period. At 516, the autonomous agent is instructed to inform the user that the return has been initiated. At 518, a guardrail indicates that the 30-day return period extends to the next business day if it falls on a weekend or holiday.

In some embodiments, an action may correspond to an invocable operation or operations that may be identified for performance by the autonomous agent via an orchestration layer implementing a planner. The actions may be identified by parsing the description of the flowchart generated via multi-modal input.

In some implementations, upon being identified, an action may be encoded as a metadata entry within a metadata framework. The metadata entry may specify information such as input to the action, output produced by performing the action, and one or more operations involved in performing the action. The stored metadata entries may be used to provide access to an autonomous agent that may be instantiated to perform the logic exemplified in the flowchart.

In some embodiments, an action may be encoded as an operation that may be performed by a database or another element of the computing services environment 200. For instance, an action may be encoded as a prompt or request transmitted to a generative language model via a generative language model gateway at the computing services environment.

### Examples of Autonomous Agent Creation from Flowcharts

In some embodiments, one or more nodes included in the flowchart may be identified based in part on legend information. For example, at 520, the action 508 is identified as being in interaction between the autonomous agent and the user. As another example, the node 518 is identified as a guardrail. As yet another example, the flowchart may include a legend that identifies node type by shape, color, and/or other characteristics.

In some embodiments, linkages between nodes may be used to specify the conditions governing traversals between the nodes. For instance, a linkage may identify information such as a source node, a destination node, and a condition for traversal between the source node and the destination node. Such linkages may be reflected in the instructions included in the autonomous agent definition. For instance, the autonomous agent definition produced from FIG. 5 may specify that the performance of action 506 is to be followed by action 510 if the customer ID and order number are valid but by action 508 if the customer ID or order number are invalid.

According to various embodiments, the agent creator may autonomously identify data needed by the autonomous agent created based on the flowchart and then identify, configure, and/or create one or more data retrievers needed to retrieve that data. For example, the agent creator may determine that in some situations performing the action 506 requires accessing the database system to determine whether the provided customer ID is associated with the provided order number. The agent creator may identify the information as being associated with an Order object in the database system. The agent creator may also determine that performing the action 510 requires determining an order date for the associated order.

According to various embodiments, based on this information, the agent creator may then identify a data retriever for retrieving information from the database system. The identified data retriever may then be configured with the query parameters needed to retrieve the information (e.g., the customer ID and order number fields) and the data retrieval parameters identifying the data to be retrieved (e.g., the order date).

Although the example shown in FIG. 5 involves data retrieved from inside the computing services environment, in some embodiments the data retriever may retrieve information from outside the computing services environment. For example, a data retriever may retrieve information from an external API, from a web search, from a social media system, or from some other external source. In some situations, authentication information for accessing such external sources may be automatically retrieved from a database system account, such as the account associated with the user using the agent or the account associated with a user creating the agent.

In some embodiments, a data retriever may be created if a suitable data creator does not already exist. For example, a data retriever metadata entry may be created that includes elements such as the data source, one or more data retrieval parameters, one or more data source access parameters, one or more data processing operations, one or more data storage operations, and/or other such parameters or operations. Additional details regarding data retrievers (also referred to herein as data connectors) are described throughout the application, such as with respect to FIG. 22 through FIG. 26.

FIG. 22 illustrates an example of flowchart input information 2200, which may be provided as input in accordance with one or more embodiments. Because it is included in a patent application, FIG. 22 has been formalized to comply with USPTO requirements. However, in some embodiments, the system described herein may receive as input an image of a flowchart that is not formalized or constructed in a standardized or predetermined manner. Alternatively, or additionally, the system may receive as input a flowchart formatted according to other specifications such as a markup language. Further, the system may accept multiple flowcharts, for instance flowcharts that are configured to work in concert.

In the flowchart input information 2200, various nodes are shown that include various elements of decision and/or processing logic. For example, at 2202, the flowchart specifies that an AI agent should check that a request includes a duration, a date, and a description. Different edges lead from the node 2202 depending on the outcome of the node 2202.

In the flowchart input information 2200, various edges are shown that identify processing outcomes determined at the corresponding nodes. For example, at 2204, an edge connecting two nodes is to be followed if it is determined that new information needs to be added by the user.

Various elements other than nodes and edges are shown in the flowchart input information 2200. For example, at 2206, a guardrail is specified. The guardrail 2206 indicates that the user may provide the start date as a date or a statement, and indicates further that dates encoded as statements should be converted to dates.

According to various embodiments, the flowchart input information 2200 may be analyzed to determine an autonomous agent definition. The autonomous agent definition may then be used to instantiate an autonomous agent to perform operations in accordance with the logic, actions, data retrievers, and guidelines identified in the flowchart input information 2200.

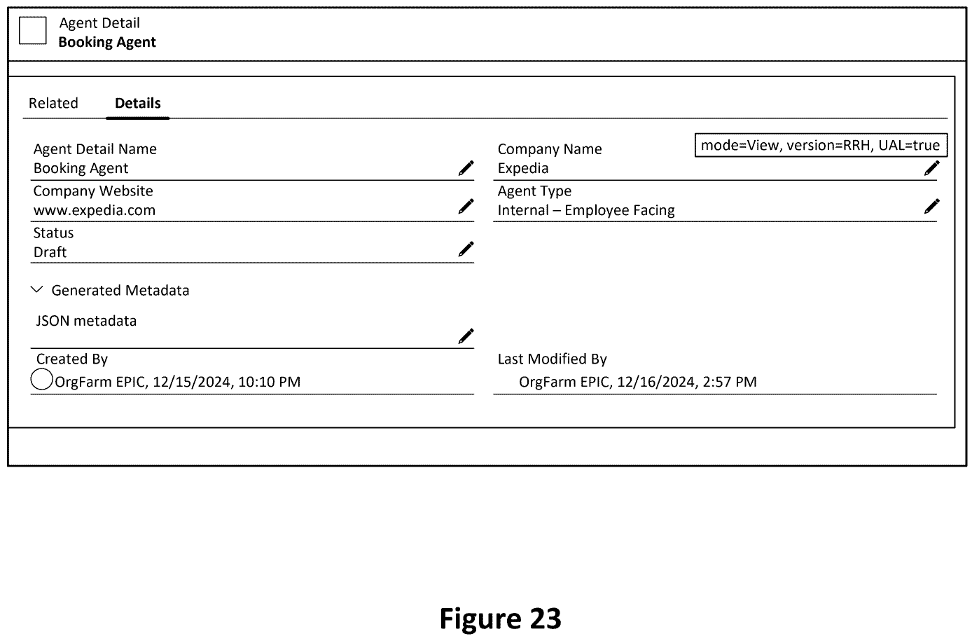

FIGS. 23-26 illustrate user interfaces generated in accordance with one or more embodiments. In particular, FIGS. 23-26 illustrate user interfaces showing definition information, configuration information, and output information associated with an autonomous agent definition and an agent instantiated based on an autonomous agent definition configured in accordance with one or more embodiments.

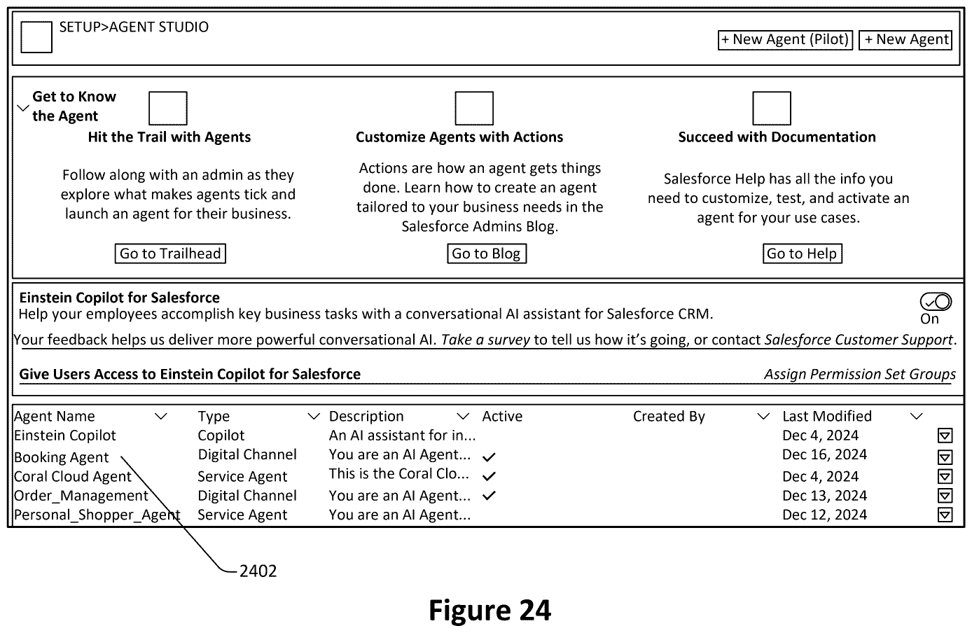

FIG. 23 and FIG. 24 illustrate examples of a user interface providing access to an agent created in accordance with techniques and mechanisms described herein. For instance, the flowchart shown in FIG. 22 corresponds to a booking agent for the website Expedia. Details for the agent definition created based on the flowchart are shown in FIG. 23. After the agent is created, it appears at 2402 in the set of available agents shown in FIG. 24.

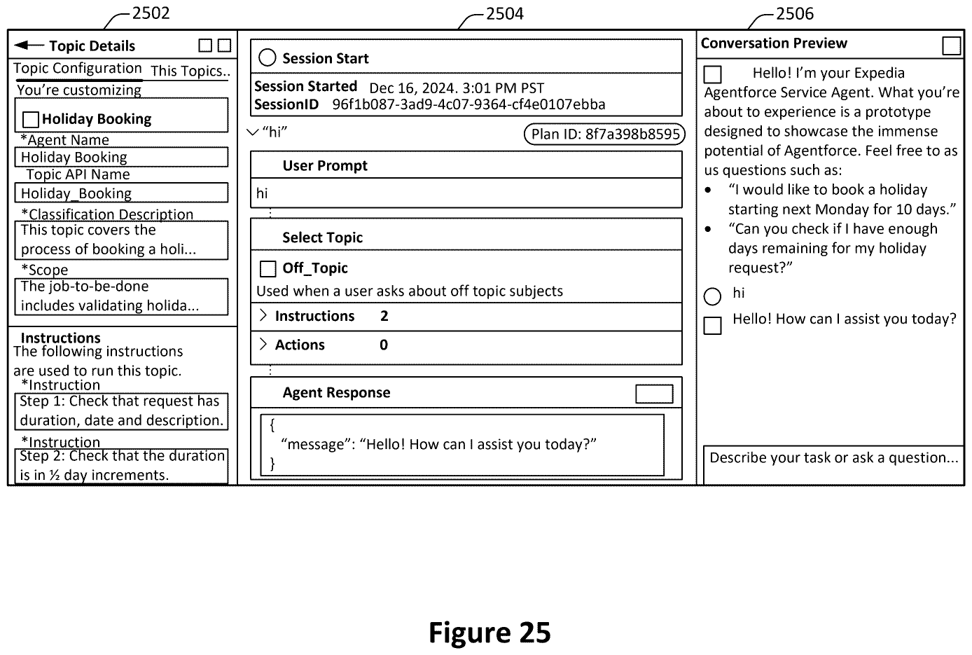

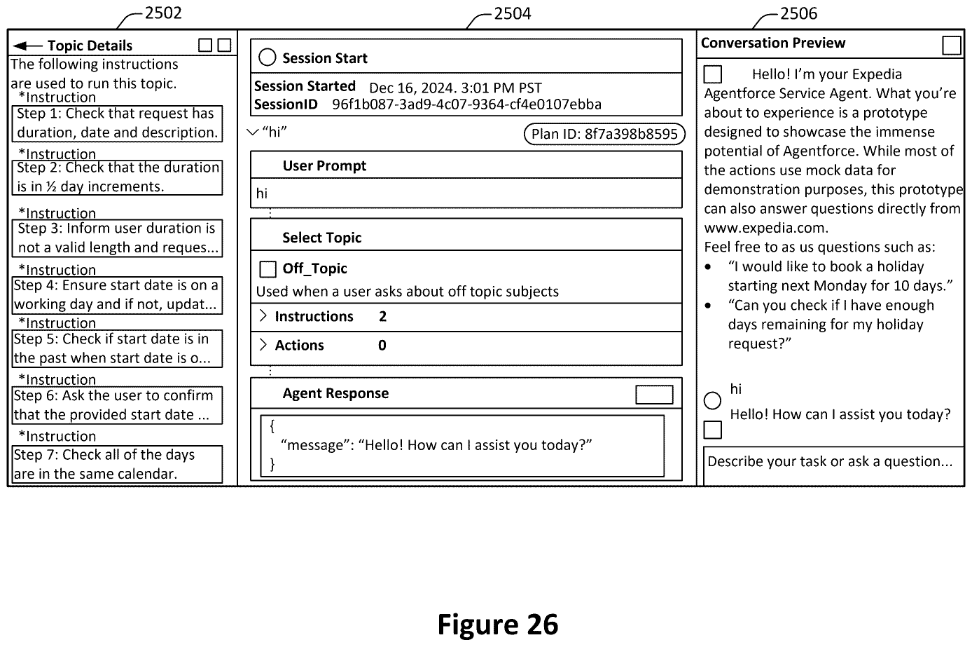

FIG. 25 and FIG. 26 illustrate examples of a configuration and testing interface for such an agent. Definition information for the agent is shown at 2502. According to various embodiments, the definition information includes fields such as the agent name, the agent topic name, the agent classification description, and the scope of operations performed by the agent.

A log associated with the execution of actions in the course of configuring and testing such an agent is shown at 2504. For instance, the log 2504 includes a user prompt 2506 in which the user provides input “hi”, and the agent responds with a message stating “Hello! How can I assist you today?” A preview of a conversation conducted via a conversational chat interface and generated based on an interaction with the agent is shown at 2506. In FIG. 26, the agent definition information 2502 shows additional details about the operations performed by the agent, such as the specific actions performed.

### Agentic AI Overview

Various embodiments described herein relate generally to artificial intelligence techniques. Generative AI models can be applied in a computing services environment in any of various ways. One way in which generative AI models may be applied involves integrating such models into existing applications. Such models are typically task-specific offering enhancements to core functionalities. For instance, generative AI models may be used to generate emails, service replies, work summaries, and the like. Such models are often tightly integrated into existing, task-specific applications. They often have limited autonomous and interactions driven by user interfaces. Although various details regarding autonomous agents are discussed in this application, additional details are discussed in U.S. patent application Ser. No. 19/037,321 by Kshirsagar et al., filed Jan. 27, 2025, titled Artificial Intelligence Agent Architecture in a Database System”, which is hereby incorporated by reference in its entirety and for all purposes.

According to various embodiments, as AI models became more sophisticated, they became integrated into autonomous agents. Such autonomous agents act as intelligent assistants, capable of understanding and responding to user queries in natural language. Autonomous agents can perform a range of tasks, from providing information to completing complex actions. Autonomous agents are often oriented around a conversational interface and employ an AI agent as the central intelligence. They provide for increased user autonomy and have expanded capabilities beyond task-specific functions.

Various embodiments described herein now provide for a platform that supports multiple agents. Agents may facilitate retrieval augmented generation, topic filtering, headless interfaces, and other complex features. Such agents can operate independently without a user interface, proactively identifying and executing tasks based on predefined goals or real-time data. They can integrate seamlessly with various systems and applications to optimize processes and achieve desired outcomes. Agents can support features such as proactive task initiation and execution, integration with multiple systems, continuous learning and improvement, and automation of complex workflows.

According to various embodiments, different agents may possess different capabilities and knowledge, collectively contributing to the system's overall intelligence. For example, one agent may specialize in data analysis, while another focuses on natural language processing.

In some embodiments, communication by agents can be powered by generative language models. Generative language models can facilitate seamless communication and collaboration among agents, allowing them to share information, coordinate actions, and/or make collective decisions.

In some embodiments, different agents may employ a shared context, which provides a common understanding of the environment, goals, and constraints involved in performing a task. The shared context helps to ensure that different agents can coordinate work towards a unified objective.

In some embodiments, different levels of AI models may be supported in the system. At the lowest level, embedded AI models may perform specific, predefined functions such as generating emails, service replies, work summaries, predicting outcomes based on structured data, classifying input, and the like. At the highest level, an agent can operate independently and autonomously, making decisions and taking actions based on its knowledge and the shared context. This autonomy allows the system to adapt to changing conditions and handle complex tasks. An autonomous agent can move beyond reactive responses and can proactively identify opportunities, anticipate user needs, and initiate actions without explicit prompts. Non-autonomous agents can provide a bridge between embedded AI applications and autonomous agents, facilitating the expansion of their capabilities. By understanding user interactions and preferences, non-autonomous agents can gather valuable data to refine AI models and algorithms, paving the way for greater autonomy.

As one example of an autonomous agent, consider the challenge that conventional sales pipelines are bogged down by time-consuming, inaccurate, and inefficient processes. Sellers spend excessive hours prospecting to generate leads, often employing a scattershot approach that yields low conversion rates. Techniques and mechanisms described herein provide for an autonomous agent configured as a sales development representative that works tirelessly to boost pipeline velocity. The autonomous agent rapidly prioritizes leads, grows pipelines, and reduces manual workload, providing a unified approach to sales orchestration across direct, indirect, and self-service channels.

As another example of an autonomous agent, consider the challenge that sales teams and representatives would like to improve performance and achieve sales targets. Techniques and mechanisms provide for a sales manager coach that offers real-time, data-driven performance analytics, coaching tools, recommendations, and performance metrics for both sales representatives and managers.

As another example, consider the challenges faced by many manufacturing companies, where procurement is in a silo, isolated from manufacturing and also completely disconnected from a customer relationship management system. Accordingly, many procurement organizations manually acquire parts, products, and supplies. Procurement departments are therefore often working with dated information, and are not processing real-time requests from CRM and Manufacturing. To address these problems, an autonomous agent may be configured. Consider the example of a requirement to acquire four specially built tires. Procurement sends an autonomous agent to search for the four tires and autonomously sources them if it finds them. If the autonomous agent can't find them, then it autonomously schedules a production run for the 4 tires, and reaches out to sales to notify the customer about lead time. Data connectors can gather the data sources and provide the data required to identify the available sources, capacity of the production line, and demand. Procurement can either source the part itself or source by the bill of materials. The autonomous agent in the sales dept could also communicate with procurement to procure the required materials and products. Other data sources may include information such as weather, anticipated demand for products, and/or anticipated product failures due to customer neglect (e.g., failure to perform maintenance). Thus, an autonomous agent may combine generative language models with other types of AI models, such as prediction models, a configuration referred to as “blended AI.”

More generally, according to various implementations, the models and/or modules described herein may include classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

According to various embodiments, techniques and mechanisms described herein address a variety of technical challenges, such as adapting generative language models to integrate with computing services environments. Computing services environment provide various types of computing services from a service provider to various client organizations. Examples of such services include, but are not limited to, those directed to customer relations management, sales relations management, supplier relations management, and database management applications. Autonomous agents may help to connect the power and flexibility of generative language models with the power and flexibility of computing services environments. However, existing approaches to autonomous agent configuration and implementation involve manually configuring autonomous agents to perform particular tasks. Such an approach suffers from various drawbacks, such as lack of testability, lack of extensibility, significant development delay, and more. In contrast, techniques and mechanisms described herein provide a set of architectures, frameworks, and methodologies facilitating autonomous agent development and implementation that in various embodiments are extensible, automatable, automated, flexible, and integrated with various computing services environment and generative language model platforms.

According to various embodiments, a computing services environment includes a wide variety of computing services arranged across a wide variety of computing devices in communication with one another. Likewise, a generative language model includes many neurons (e.g., millions, billions, or more) arranged in complex neural networks configured to perform sophisticated generative tasks. Coordinating between such systems involves a host of operations, including those related to processing, communication, architecture, coordination, monitoring, feedback, auditing, logging, and more. Any method performed by a system operating at the intersection of a computing services environment and a generative language model is, therefore, necessarily incapable of being performed in the human mind. In such a context, even a seemingly simple operation involves such a wide range of computing resources that a human mind would be incapable of performing the operation in the context of a method or system implemented as described herein. For example, although a human mind is capable of generating text, the human mind is incapable of executing a generative language model to generate text to complete a prompt specified in accordance with one or more embodiments.

### Agent Platform Overview

FIG. 6 illustrates a computing services environment 600, configured in accordance with one or more embodiments. The computing services environment 600 includes an agent platform 602 and other computing services environment components 642. The agent platform 602 includes a unified metadata framework 604, an agent studio 612, an agent library 620, an orchestration, planning, and reasoning layer 626, an action repository 628, a trust layer 630, a model gateway 632, an AI platform 634, a data interface 636, a virtualization interface 638, and a communication interface 640. The agent library 620 includes the agents 622 through 624. The unified metadata framework 604 includes a user interface layer 606, a model layer 608, and a data layer 610. The agent studio 612 includes a prompt studio 614, an assistant studio 616, and an action studio 618.

According to various embodiments, the unified metadata framework 604 may facilitate the configuration of agents as well as interactions between various elements of the computing services environment 600 and the autonomous agent platform 602. For instance, various operations, data objects, and other resources within the computing services environment 600 may be defined as metadata entries within the unified metadata framework 604. Agents may then be constructed using those metadata entries as building blocks.

In some embodiments, the user interface layer 602 facilitates the specification of various applications and workflows 644. Such applications and workflows may include operations performed within and/or outside of the computing services environment 600. For example, applications and workflows may be specific to types of services provided via the computing services environment 600, such as sales, service, marketing, commerce, data analysis, and the like. As another example, applications and workflows may include domain-specific operations, such as those specific to healthcare, finance, or other industries.

In some embodiments, the user interface layer 602 facilitates the specification of agents 646 such as conversational chat assistants. For example, the computing service environment 600 may provide one or more standard conversational chat assistants that may be accessed through user interfaces provided via the computing services environment 600 or via other communication channels such as email, SMS, or external chat services. As another example, an autonomous agent may be customized by, for instance, an organization accessing computing services via the computing services environment 600.

In some embodiments, the agents 646 may be configured to perform various tasks within the system. Examples of agents may include, but are not limited to, customized agents, coaching agents, sales development agents, and customer service agents. Agents may be represented in the unified metadata framework 604 in the user interface layer 606 and may be stored in the agent library 620.

According to various embodiments, one or more of the agents may be autonomous AI agents. Autonomous AI agents (also referred to herein as autonomous agents) may be capable of autonomous or semi-autonomous activation and/or operation. However, not all AI agents are necessarily entirely autonomous. For instance, some AI agents may operate under human control and instruction, for instance eliciting human confirmation before performing some types of actions.

According to various embodiments, an agent may perform operations such as receiving user input, executing one or more applications, workflows, actions, or operations within the computing services environment 600, and/or interacting with a database system, generative language model, other artificial intelligence models, and/or other system accessible via the computing services environment 600.

According to various embodiments, the model layer 604 provides for secure interaction with one or more artificial intelligence models. For instance, the model layer may define access information for performing actions such as retrieving data and accessing AI models via the trust layer 630, the model gateway 632, the AI platform 634, and the data interface 636.

According to various embodiments, the trust layer 630 is configured to perform operations such as masking personally identifying information, securely retrieving data, detecting toxic language generated by a generative language model, and defending prompt completions against injection attacks and other attacks. Thus, the trust layer may provide additional protections for various actions performed in the context of various applications, workflows, and autonomous agents.

In some implementations, the data layer 606 defines data retrievers providing access to data sources, which may be located inside or outside of the computing services environment 600. Examples of such data sources may include, but are not limited to: structured data sources, unstructured data sources, data lakes, vector databases, relational databases, unified user profiles, data-based actions, data warehouses, and data lakehouses.

In some embodiments, an agent may be used to perform one or more tasks within the computing services environment 600. For example, an autonomous agent may interactively converse with a user in natural language. As another example, an agent may interact with one or more artificial intelligence models, including one or more generative language models, one or more predictive models, one or more classification models, and/or one or more other types of models. As yet another example, an autonomous agent may retrieve information from a database system, store information to a database system, transmit one or more messages, and/or take other actions within the computing services environment 600.

In some embodiments, the agent studio 612 allows for the construction and customization of various aspects of the agent platform 600 and/or agents accessible via the agent platform 600. The agent studio 612 may include elements such as a user interface, metadata information, monitoring, governance, and/or search tools for building agents. For example, the agent studio 612 may provide support for constructing one or more prompts, actions, applications, workflows, or the like.

The agent studio 612 includes a prompt studio 614, an assistant studio 616, and an action studio 618. According to various embodiments, the agent studio 612 provides functionality for the configuration of assistants, actions, and prompts to support agent platform customized for a customer organization. For example, a user may build, test, and integrate prompts, actions, and/or autonomous agents into one or more applications provided by or interoperating with the computing services environment 600 to support the performance of various tasks for an organization.

Agents 622 through 624 may be stored in the agent library 604. One or more agents may be configured in a standardized format and/or template for use by various organizations and individuals accessing computing services via the computing services environment 600. Additionally, one or more agents may be customized for particular industries, organizations, individuals, applications, and/or other contexts.

At 626, an orchestration, planning, and reasoning layer provides for the execution of an agent to interpret, decompose, and implement actions based on user inputs. For example, a user instruction such as “draft an email summarizing this record” may be analyzed to identify an overall intent. The user instruction may also be decomposed into actions such as “summarize a record” and “draft an email using the summary”. The decomposition and overall intent may be used to orchestrate and execute a plan, which may involve identifying the focal record, determining and completing one or more prompts to determine the summary, and determining and completing one or more prompts to draft an email using the summary. Additional details regarding the formulation and execution of such a plan are discussed throughout the application.

According to various embodiments, the action repository 628 may include one or more actions that are preconfigured to perform tasks within the computing services environment 600. For instance, an action repository may include actions such as “summarize a record” or “draft an email.” An autonomous agent may identify and execute such actions in order to implement a user's intent or accomplish other objectives assigned to the autonomous agent.

In some embodiments, one or more of the actions may be specific to a particular domain. For instance, one or more actions in the health or finance domains may include particular constraints, such as instructions provided to a generative language model, to provide for compliance with relevant laws and regulations.

In some embodiments, one or more of the actions may be configurable and/or user-defined. For instance, a user associated with an organization accessing computing services via the computing services environment 600 may provide code and/or other action definition information specifying an action to be performed. The defined action may then be incorporated into an orchestration or workflow.

The model gateway 632 provides access to one or more generative language models or other artificial intelligence models. In some embodiments, agents may be supported by a range of different generative language models. For example, a customer organization may be able to use standardized models provided by model providers such as Open AI, Microsoft Azure, Gemini, or the like. As another example, the model gateway 632 may also support customized models, for instance models customized and/or hosted by a customer organization. As yet another example, the model gateway 632 may provide access to models hosted within the computing service environment 600.

In some embodiments, an AI agent may be configured to employ different models for different aspects of the agent. For example, one model (e.g., Gemini) may be used for a function such as “summarize record”, while another model (e.g., Open AI) may be used for a function such as “draft email”. In this way, an AI agent may be flexibly adapted to execute a variety of different operations.

In some embodiments, the model gateway 632 may provide a feedback framework for receiving user feedback. The user feedback may be stored in the database and may be used for a variety of purposes, such as finetuning an autonomous agent and/or one or more of the underlying generative language models.

The AI platform 634 may provide support for generative language models and other types of AI models hosted by the service provider of the computing services environment 600 and/or one or more partner or customer organizations. For example, the customer organization may provide their own generative language model, such as a hosted generative language model. As another example, the customer may employ a customer-tuned version of a standard model, such as the customer's version of a model provided by Azure or Gemini. As still another example, an agent may employ a standard generative language model hosted by the service provider of the computing services environment 600.

The data interface 636 provides access to one or more of a variety of data sources. According to various embodiments, an agent may access one or more data sources to support the autonomous agent operations. For example, an agent may access third party data sources such as Google Cloud, Google BigQuery, Amazon S3, or Microsoft Azure. As another example, an agent may access one or more data sources from inside the computing services environment, such as customer relations management data. As still another example, an agent may access data from other sources, such as legacy systems, external apps, mobile sources, web sources, software development kids, and/or application procedure interfaces. Examples of data interfaces may include, but are not limited to: data lakehouses, real-time data services, zero-ETL data services, united profiles, data actions, data connectors, relational database systems, and any other interfaces for accessing structured, unstructured, or semi-structured data sources.

At 638, a virtualization platform provides for the ability to deploy one or more aspects of the platform provided via the computing services environment in one or more virtual environments. For example, data residency requirements may be enforced, ensuring that data resides in a particular location. As another example, communications may be encrypted end-to-end. As still another example, one or more regulatory requirements may be enforced. The virtualization platform 638 may allow all or a portion of the computing services environment 600 to be deployed in a different location, such as within a hosted environment (e.g., Google Compute, Amazon AWS, etc.).

The communication interface 640 facilitates communication with one or more client machines via any of various communication channels. For example, depending on the system configuration, a client machine may communicate with an autonomous agent via a web interface, a messaging application (e.g., Slack), email, voice, SMS messages, and/or any other suitable communication channel. Some such channels may be embedded into other applications, such as web applications accessible via the computing services environment 600 or native applications accessed via a client machine.

According to various embodiments, as shown in the other computing services environment components 642, the computing services environment 600 may include various elements and components other than those shown in FIG. 6.

FIG. 7 illustrates a method 700 providing an overview of the lifecycle of an autonomous agent, performed in accordance with one or more embodiments. According to various embodiments, the method 700 may be performed at a computing services environment such as the computing services environment 600 shown in FIG. 6.

At 702, an autonomous agent is defined by specifying a set of metadata entries in a metadata framework within the computing services environment. The metadata entries may be stored in a database system within the computing services environment. The metadata entries may include a set of action definitions defining actions capable of being taken by the autonomous agent within the computing services environment. The metadata entries may also include a triggering condition for triggering the autonomous agent.

In some embodiments, the agent and/or one or more of the actions may be defined by the service provider of the computing services environment. Alternatively, or additionally, the agent and/or one or more of the actions may be customized by a client accessing computing services via the computing services environment. In such a configuration, the customized autonomous agent may be specific to the client and may be unavailable to other clients accessing computing services within the computing services environment.

In some embodiments, an autonomous agent may be configured for operation within a portion of the computing services environment. For instance, the autonomous agent may be configured to operate within one or more on-demand computing applications, computing clouds, chat interfaces, operational contexts, data sets, data object types, or the like.

In some embodiments, the triggering condition may include an explicit request by a user to instantiate the autonomous agent. For instance, the autonomous agent may be instantiated based on one or more natural language user instructions received via a communication channel. Alternatively, or additionally, the triggering condition may specify one or more conditions under which the autonomous agent is autonomously instantiated. For example, the autonomous agent may be instantiated automatically when a database record is created or updated with a database field value that meets one or more defined characteristics. As another example, the autonomous agent may be instantiated automatically by a workflow within the computing services environment 600. As yet another example, the autonomous agent may be instantiated upon request as part of the execution of a different autonomous agent.

The autonomous agent is autonomously instantiated at 704 upon the detection of the triggering condition within the computing services environment. The triggering condition and hence the instantiation of the autonomous agent may be associated with a context for operating the autonomous agent. The context may specify one or more elements of an initial state of the autonomous agent. For instance, the context may identify information such as a client organization, a user account, natural language input received via a communication channel.

An execution plan is determined at 706 by selecting a subset of the actions based on the context. The execution plan may be determined by formulating a prompt for completion by a generative language model. The prompt may include information such as a set of action descriptions and action identifiers, as well as information associated with the context such as natural language user input. The prompt may include instructions to generate text including identifiers for actions that are selected by the generative language model based on the context, the instructions, and the action descriptions.

In some embodiments, determining the execution plan may involve multiple operations, executed in sequence or in parallel. For example, a particular planner and/or agent of a set of available planners and/or agents may first be selected. As another example, a topic or topics may be selected from a set of available topics, and the actions available for selection may be first filtered to the topic or topics. Such an approach may reduce the number of action descriptions that need to be included in the plan determination prompt that is completed by the generative language model to determine the plan.

The subset of actions are executed within the computing services environment 600 at 708. Executing the actions may involve performing any of a variety of operations. In particular, one or more data records stored within the database system within the computing services environment may be updated. Other examples of the types of operations that may be performed may include, but are not limited to: retrieving data from inside and/or outside the computing services environment, determining novel text, updating computing services environment logging data, executing one or more artificial intelligence and/or machine learning models inside and/or outside the computing services environment, transmitting messages to communicate with client machines and/or other devices, and the like. As discussed herein, an action may potentially include any operation or operations capable of being performed within the computing services environment.

The method 700 provides a general overview of the operations that may be performed in the lifecycle of an autonomous agent. Additional details regarding these operations, such as the creation of an autonomous agent, the instantiation of an autonomous agent, the determination of an execution plan, and the execution of the actions within an execution plan, are discussed throughout the application.

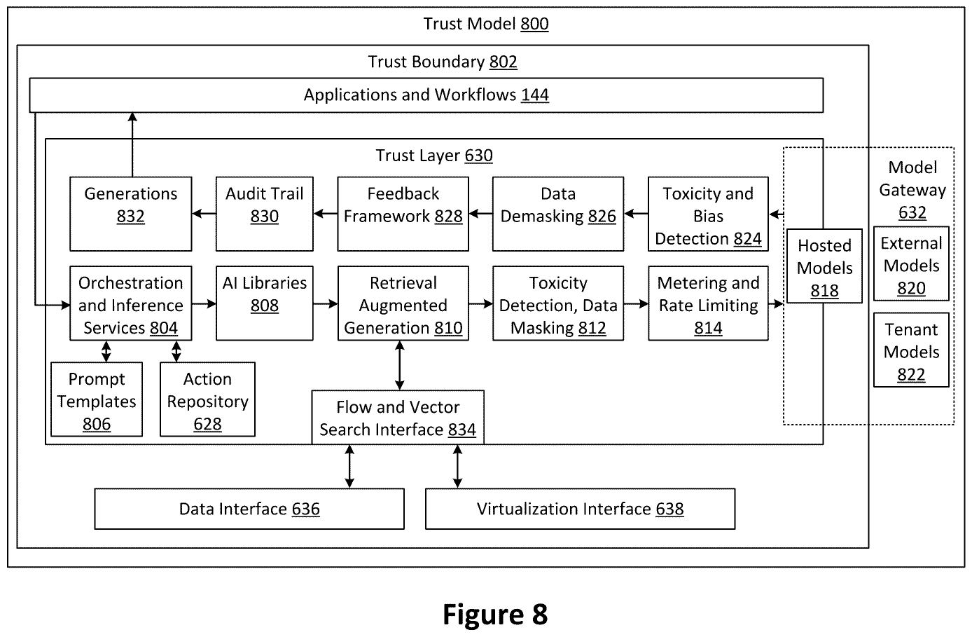

FIG. 8 illustrates a trust model 800 for the autonomous agent platform, configured in accordance with one or more embodiments. The trust model 800 includes a trust boundary 802. Inside the trust boundary 802 are the applications and workflows 644, the trust layer 630, the data interface 636, and the virtualization interface 638.

In some embodiments, the trust boundary 802 may separate internal from external services. Inside the trust boundary, at 630, a trust layer may provide for the execution of various trust related operations. Outside the trust boundary, one or more external services or models may operate in an untrusted zone or a zone of shared trust.

The trust layer 630 includes one or more orchestration and inference services 804, one or more artificial intelligence libraries 808, one or more retrieval augmented generation services 810, one or more inbound toxicity detection and/or data masking services 812, one or more metering and rate limiting services 814, one or more outbound toxicity and bias detection services 824, one or more data demasking services 826, a feedback framework 828, an audit trail service 830, generations 832, prompt templates 806, and a one or more flow and/or vector search services 834.

For the purpose of illustration, the trust model 800 is shown with arrows illustrating a simple flow that may employ various components. In practice, however, the trust layer 630 may be used to perform various types of complex operations that may operate outside the linear flow illustrated in the trust model 800. However, the simple flow shown in FIG. 8 may be used to understand the operation and interaction of the various elements included in the trust layer 630.

For the purpose of illustration, consider a request generated by one or more applications and workflows 644. For instance, the request may be natural language text input provided by a user, an operation instruction triggered by an action performed in the context of an application, or some other type of request. Such a request may be sent to the orchestration and inference services 804.

According to various embodiments, the orchestration and inference services 804 may analyze the request to determine an intent, execute one or more actions, generate novel text, interact with the database system, receive and/or transmit one or more messages, and/or perform other types of operations. In service of performing these operations, the orchestration and inference services 804 may access one or more prompt templates 806, one or more actions stored in the action repository 628, and/or other preconfigured definitions or templates.

According to various embodiments, the orchestration and inference services 804 may transmit information to one or more artificial intelligence libraries 808, which may trigger the retrieval of information via the one or more retrieval augmented generation services 810. The one or more retrieval augmented generation services 810 may retrieve information from inside and/or outside of the computing services environment via the data interface 636 and/or the virtualization interface 638 through the flow and/or vector search interface 834. Retrieved information may be added to a prompt template or used to perform an action.

In some embodiments, prompts and other requests to artificial intelligence models may be processed via one or more toxicity detection and/or data masking services 812. Toxicity detection services, bias detection services, and/or other such evaluators may seek to determine whether a request is likely to generate text or other output deemed biased, offensive, or otherwise unacceptable or impermissible. Data masking may replace some information, such as personally identifying information, with blanks, unique identifiers, or other such values.

In some implementations, requests may be further processed via one or more metering and/or rate limiting services 814. Metering and/or rate limiting services 814 may help to ensure that requests to models do not exceed a designated rate. For instance, one or more requests may be queued to ensure that a request rate for a designated model, user, organization, or other context does not exceed a designated threshold.

In some implementations, requests to models may be sent via the model gateway 632. According to various embodiments, the model gateway 632 may be used to access one or more hosted models 818 hosted by the computing services environment 600, one or more tenant models 822 hosted by a customer organization, and/or one or more external models 820 hosted by a third-party service provider. Depending on the configuration, different models may reside inside of the trust layer, outside of the trust layer, and/or in an intermediate zone such as a shared trust environment.

In some embodiments, responses from models, such as prompt completions generated by a generative language model, may be evaluated for toxicity and bias by one or more toxicity and/or bias detection services at 824. Such evaluation may help to ensure that the system does not perform operations or return text that includes impermissible, objectionable, offensive content.

According to various embodiments, data demasking may be performed at 826. For instance, personally identifying information in an input prompt to a generative language model may be replaced with randomly generated unique identifiers by one or more data masking services 812. Then, when the generative language model returns a prompt completion that includes one or more of the randomly generated unique identifiers, the identifiers may be replaced with the personally identifying information. In this way, the system may generate text and/or take other actions that include or reflect personally identifying information, while at the same time not exposing such information to services outside the trust model such as externally hosted generative language models.

In some embodiments, feedback regarding actions, text generated by large language models, and/or other such operations may be determined and stored via the feedback framework 828. Such information may be used to train models, guide subsequent actions, and/or otherwise refine the operations of an autonomous agent.

In some implementations, the audit trail service 830 may aggregate and store information used to provide a record of actions taken by the system in the course of executing operations associated with an autonomous agent. Such information may be stored in a database system accessible via the computing services environment 600.

In some embodiments, text and other output generated as part of the processing of requests from the requests and workflows 608 may be returned to the applications and workflows 608 as generations at 832. Generations 832 may include, but are not limited to: text to be presented in a chat interface, instructions regarding actions to be performed in the context of providing an application or workflow, or other such information.

In some implementations, generations may be extracted from novel text generated by a generative language model. For instance, a generative language model may be provided with a prompt that includes information such as: (1) one or more natural language instructions to be executed by the generative language model, (2) input data to be used by the generative language model as needed in the course of executing the one or more natural language instructions, (3) one or more parameters governing the execution of the one or more natural language instructions, (4) any other information. The input data may include text data, structured data, unstructured data, or any other type of data. The generative language model may then execute the one or more natural language instructions to generate novel text.

In some embodiments, the novel text may include natural language, such as natural language to include in a message to a user, a field in a database record, a computing services environment log, or the like. Alternatively, or additionally, the novel text may include data, such as numerical data to use in updating a database record, data indicating a selection of one or more computing resources and elements within the computing services environment. For example, computing resources and elements such as topics, actions, computing devices, clients, users, and more may be associated with corresponding unique identifiers. The generative language model may generate novel text that includes such unique identifiers. The unique identifiers may then be extracted from the novel text by the computing services environment and used to trigger and/or inform the performance of operations within the computing services environment.

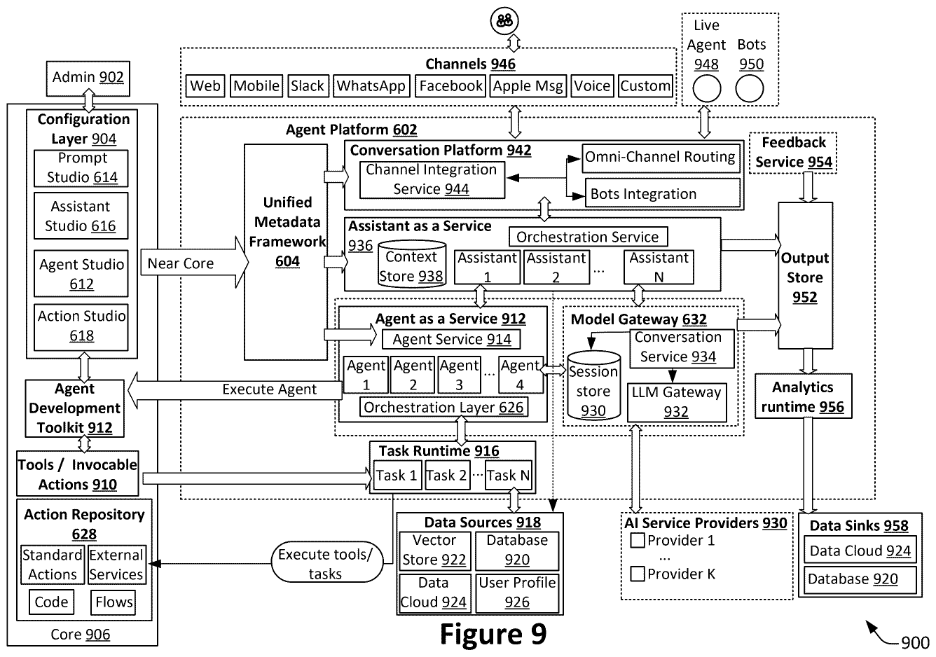

FIG. 9 illustrates an architecture diagram 900 of elements of the computing services environment 600, configured in accordance with one or more embodiments. The architecture diagram 900 is provided to illustrate additional details related to the operation of the computing services environment 600 with respect to the agent platform 602.

In the architecture diagram 900, an administrator 902 or other user interacts with an agent configuration layer 904 within the core 906 of the computing services environment. The configuration layer includes various elements, discussed in FIG. 6, for configuring agents. Collectively these tools provide access to an agent development toolkit 912 for defining and configuring tools and invocable actions 910 within the computing services environment. An agent may be composed of metadata references to such tools and invocable actions 910, as well as other metadata entries.

According to various embodiments, metadata entries may be specified within the unified metadata framework 604 within the agent platform 602. The metadata entries may be used to specify actions and operations associated with elements within the agent platform 602 used to provide the agents.

In some implementations, as a central element, the agent as a service platform 912 provides for the instantiation and execution of agents via the agent service 914. The orchestration layer 626 may be used to perform operations such as selecting agents, selecting planners, and determining plans. When an agent performs an action, the action may be implemented as a task executed by the task runtime 916.

In some embodiments, executing a task may involve retrieving data from one or more of the data sources 918. The data sources 918 may include a variety of data sources inside and/or outside of the computing services environment 600, including the database system 920, a vector store 922, a data cloud 924 providing access to, for instance, unstructured data, and user profiles 926.

In some embodiments, as another central element, the agent as a service platform 912 may coordinate with the model gateway 628 to communicate with generative language models and/or other artificial intelligence and/or machine learning models. The conversation service 934 may coordinate the generation of natural language text via the LLM gateway 932. The service platform 912 may communicate with AI service providers 930, which may be located inside or outside of the computing services environment 600.

According to various embodiments, as a particular kind of agent, conversational chat assistants may be accessed via the assistant as a service platform 936. Information pertaining to instances of conversational chat assistants may be stored in the context store 938. For instance, records of conversations as well as other supporting metadata may be used to save the state of a conversational chat assistant and then restore the state at a later point in time. A conversational chat assistant orchestration service 940 may coordinate operations of conversational chat assistants, including communication via the conversation platform 942. The conversation platform 942 may coordinate communication via various communication channels 946 via a channel integration service 944. Any of a variety of communication channels may be supported, including custom channels defined by customer organizations of the computing services environment 600. The conversation platform 942 may also support agent interactions with human agents 948 and/or computing programs 950 located outside of the agent platform 602.

According to various embodiments, information determined by the agents may be stored to an output store 952. Feedback regarding agent performance may be provided via a feedback service 954, and information analyzed via an analytics runtime 956 may be stored to one or more data sinks 958, such as the database system 920 and/or the data cloud 924.

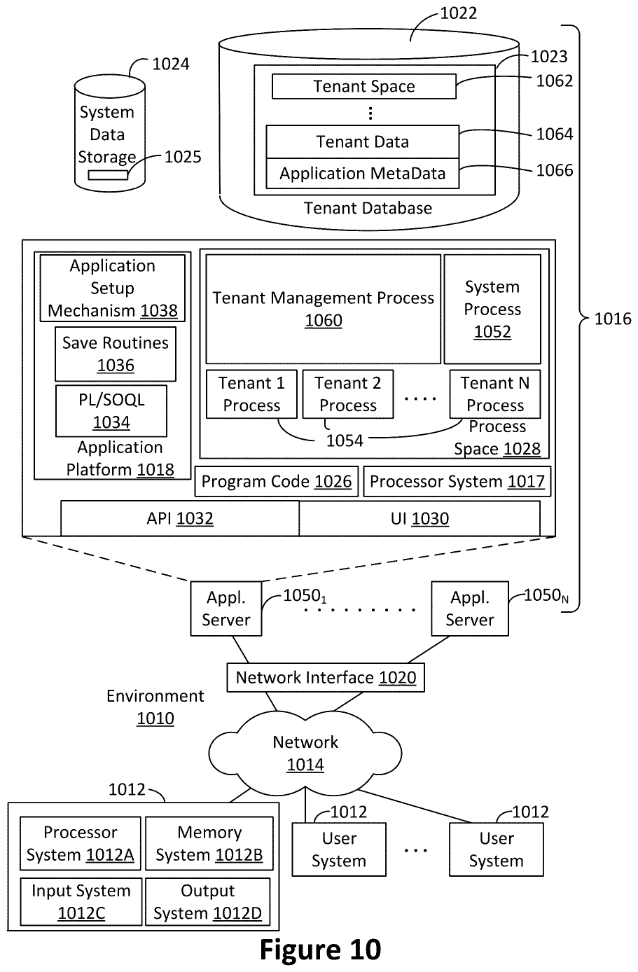

FIG. 10 shows a block diagram of an example of an environment 1010 that includes an on-demand database service configured in accordance with some implementations. Environment 1010 may include user systems 1012, network 1014, database system 1016, processor system 1017, application platform 1018, network interface 1020, tenant data storage 1022, tenant data 1023, system data storage 1024, system data 1025, program code 1026, process space 1028, User Interface (UI) 1030, Application Program Interface (API) 1032, PL/SOQL 1034, save routines 1036, application setup mechanism 1038, application servers 1050-1 through 1050-N, system process space 1052, tenant process spaces 1054, tenant management process space 1060, tenant storage space 1062, user storage 1064, and application metadata 1066. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

According to various embodiments, the environment 1010 may provide access to an agent platform. As shown in FIG. 10, the environment 1010 may also include other elements beyond the agent platform, such as computing components used to provide other types of computing services. Agents accessible via the agent platform may interoperate with such computing services. For instance, agents may trigger, configure, be triggered by, and/or accessed via such computing services.

An on-demand database service, implemented using system 1016, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1018 may be a framework that allows the creation, management, and execution of applications in system 1016. Such applications may be developed by the database service provider or by users or third-party application developers accessing the service. Application platform 1018 includes an application setup mechanism 1038 that supports application developers' creation and management of applications, which may be saved as metadata into tenant data storage 1022 by save routines 1036 for execution by subscribers as one or more tenant process spaces 1054 managed by tenant management process 1060 for example. Invocations to such applications may be coded using PL/SOQL 1034 that provides a programming language style interface extension to API 1032. A detailed description of some PL/SOQL language implementations is discussed in commonly assigned U.S. Pat. No. 10,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1066 for a subscriber making such an invocation. Such system processes may also manage execution of application metadata 1066 as an application in a virtual machine.

In some implementations, each application server 1050 may handle requests for any user associated with any organization. A load balancing function (e.g., an F5 Big-IP load balancer) may distribute requests to the application servers 1050 based on an algorithm such as least-connections, round robin, observed response time, etc. Each application server 1050 may be configured to communicate with tenant data storage 1022 and the tenant data 1023 therein, and system data storage 1024 and the system data 1025 therein to serve requests of user systems 1012. The tenant data 1023 may be divided into individual tenant storage spaces 1062, which can be either a physical arrangement and/or a logical arrangement of data. Within each tenant storage space 1062, user storage 1064 and application metadata 1066 may be similarly allocated for each user. For example, a copy of a user's most recently used (MRU) items might be stored to user storage 1064. Similarly, a copy of MRU items for an entire tenant organization may be stored to tenant storage space 1062. A UI 1030 provides a user interface and an API 1032 provides an application programming interface to system 1016 resident processes to users and/or developers at user systems 1012.

System 1016 may implement a web-based generative language model system. For example, in some implementations, system 1016 may include application servers configured to implement and execute generative language model software applications. The application servers may be configured to provide related data, code, forms, web pages and other information to and from user systems 1012. Additionally, the application servers may be configured to store information to, and retrieve information from a database system. Such information may include related data, objects, and/or Webpage content. With a multi-tenant system, data for multiple tenants may be stored in the same physical database object in tenant data storage 1022, however, tenant data may be arranged in the storage medium(s) of tenant data storage 1022 so that data of one tenant is kept logically separate from that of other tenants. In such a scheme, one tenant may not access another tenant's data, unless such data is expressly shared.

Several elements in the system shown in FIG. 10 include conventional, well-known elements that are explained only briefly here. For example, user system 1012 may include processor system 1012A, memory system 1012B, input system 1012C, and output system 1012D. A user system 1012 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1012 to access, process and view information, pages and applications available from system 1016 over network 1014. Network 1014 may be any network or combination of networks of devices that communicate with one another, such as any one or any combination of a LAN (local area network), WAN (wide area network), wireless network, or other appropriate configuration.

The users of user systems 1012 may differ in their respective capacities, and the capacity of a particular user system 1012 to access information may be determined at least in part by “permissions” of the particular user system 1012. As discussed herein, permissions generally govern access to computing resources such as data objects, components, and other entities of a computing system, such as a generative language model platform, a social networking system, and/or a CRM database system. “Permission sets” generally refer to groups of permissions that may be assigned to users of such a computing environment. For instance, the assignments of users and permission sets may be stored in one or more databases of System 1016. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1016 may provide on-demand database service to user systems 1012 using an MTS arrangement. By way of example, one tenant organization may be a company that employs a sales force where each salesperson uses system 1016 to manage their sales process. Thus, a user in such an organization may maintain contact data, leads data, customer follow-up data, performance data, goals and progress data, etc., all applicable to that user's personal sales process (e.g., in tenant data storage 1022). In this arrangement, a user may manage his or her sales efforts and cycles from a variety of devices, since relevant data and applications to interact with (e.g., access, view, modify, report, transmit, calculate, etc.) such data may be maintained and accessed by any user system 1012 having network access.

When implemented in an MTS arrangement, system 1016 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1016 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1016 may also maintain system-level data usable by multiple tenants or other data. Such system-level data may include industry reports, news, postings, and the like that are sharable between tenant organizations.

In some implementations, user systems 1012 may be client systems communicating with application servers 1050 to request and update system-level and tenant-level data from system 1016. By way of example, user systems 1012 may send one or more queries requesting data of a database maintained in tenant data storage 1022 and/or system data storage 1024. An application server 1050 of system 1016 may automatically generate one or more SQL statements (e.g., one or more SQL queries) that are designed to access the requested data. System data storage 1024 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 10,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

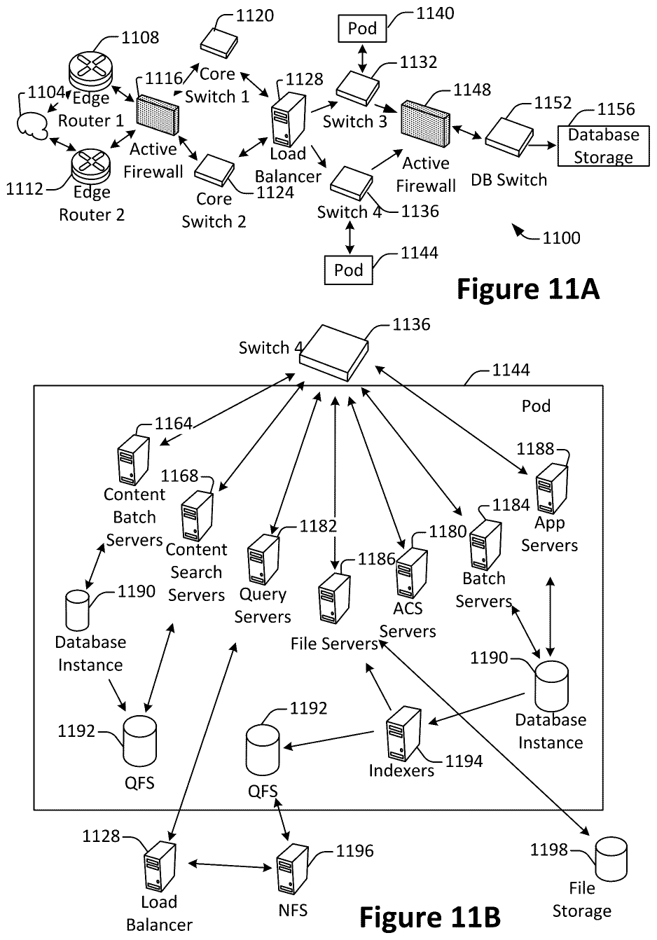

FIG. 11A shows a system diagram of an example of architectural components of an on-demand database service environment 1100, configured in accordance with some implementations. A client machine located in the cloud 1104 may communicate with the on-demand database service environment via one or more edge routers 1108 and 1112. A client machine may include any of the examples of user systems 1012 described above. The edge routers 1108 and 1112 may communicate with one or more core switches 1120 and 1124 via firewall 1116. The core switches may communicate with a load balancer 1128, which may distribute server load over different pods, such as the pods 1140 and 1144 by communication via pod switches 1132 and 1136. The pods 1140 and 1144, which may each include one or more servers and/or other computing resources, may perform data processing and other operations used to provide on-demand services. Components of the environment may communicate with a database storage 1156 via a database firewall 1148 and a database switch 1152.

Accessing an on-demand database service environment may involve communications transmitted among a variety of different components. The environment 1100 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 11A and 11B.

The cloud 1104 refers to any suitable data network or combination of data networks, which may include the Internet. Client machines located in the cloud 1104 may communicate with the on-demand database service environment 1100 to access services provided by the on-demand database service environment 1100. By way of example, client machines may access the on-demand database service environment 1100 to retrieve, store, edit, and/or process generative language model information.

In some implementations, the edge routers 1108 and 1112 route packets between the cloud 1104 and other components of the on-demand database service environment 1100. The edge routers 1108 and 1112 may employ the Border Gateway Protocol (BGP). The edge routers 1108 and 1112 may maintain a table of IP networks or ‘prefixes’, which designate network reachability among autonomous systems on the internet.

In one or more implementations, the firewall 1116 may protect the inner components of the environment 1100 from internet traffic. The firewall 1116 may block, permit, or deny access to the inner components of the on-demand database service environment 1100 based upon a set of rules and/or other criteria. The firewall 1116 may act as one or more of a packet filter, an application gateway, a stateful filter, a proxy server, or any other type of firewall.

In some implementations, the core switches 1120 and 1124 may be high-capacity switches that transfer packets within the environment 1100. The core switches 1120 and 1124 may be configured as network bridges that quickly route data between different components within the on-demand database service environment. The use of two or more core switches 1120 and 1124 may provide redundancy and/or reduced latency.

In some implementations, communication between the pods 1140 and 1144 may be conducted via the pod switches 1132 and 1136. The pod switches 1132 and 1136 may facilitate communication between the pods 1140 and 1144 and client machines, for example via core switches 1120 and 1124. Also or alternatively, the pod switches 1132 and 1136 may facilitate communication between the pods 1140 and 1144 and the database storage 1156. The load balancer 1128 may distribute workload between the pods, which may assist in improving the use of resources, increasing throughput, reducing response times, and/or reducing overhead. The load balancer 1128 may include multilayer switches to analyze and forward traffic.

In some implementations, access to the database storage 1156 may be guarded by a database firewall 1148, which may act as a computer application firewall operating at the database application layer of a protocol stack. The database firewall 1148 may protect the database storage 1156 from application attacks such as structure query language (SQL) injection, database rootkits, and unauthorized information disclosure. The database firewall 1148 may include a host using one or more forms of reverse proxy services to proxy traffic before passing it to a gateway router and/or may inspect the contents of database traffic and block certain content or database requests. The database firewall 1148 may work on the SQL application level atop the TCP/IP stack, managing applications' connection to the database or SQL management interfaces as well as intercepting and enforcing packets traveling to or from a database network or application interface.

In some implementations, the database storage 1156 may be an on-demand database system shared by many different organizations. The on-demand database service may employ a single-tenant approach, a multi-tenant approach, a virtualized approach, or any other type of database approach. Communication with the database storage 1156 may be conducted via the database switch 1152. The database storage 1156 may include various software components for handling database queries. Accordingly, the database switch 1152 may direct database queries transmitted by other components of the environment (e.g., the pods 1140 and 1144) to the correct components within the database storage 1156.

FIG. 11B shows a system diagram further illustrating an example of architectural components of an on-demand database service environment, in accordance with some implementations. The pod 1144 may be used to render services to user(s) of the on-demand database service environment 1100. The pod 1144 may include one or more content batch servers 1164, content search servers 1168, query servers 1182, file servers 1186, access control system (ACS) servers 1180, batch servers 1184, and app servers 1188. Also, the pod 1144 may include database instances 1190, quick file systems (QFS) 1192, and indexers 1194. Some or all communication between the servers in the pod 1144 may be transmitted via the switch 1136.

In some implementations, the app servers 1188 may include a framework dedicated to the execution of procedures (e.g., programs, routines, scripts) for supporting the construction of applications provided by the on-demand database service environment 1100 via the pod 1144. One or more instances of the app server 1188 may be configured to execute all or a portion of the operations of the services described herein.

In some implementations, as discussed above, the pod 1144 may include one or more database instances 1190. A database instance 1190 may be configured as an MTS in which different organizations share access to the same database, using the techniques described above. Database information may be transmitted to the indexer 1194, which may provide an index of information available in the database 1190 to file servers 1186. The QFS 1192 or other suitable filesystem may serve as a rapid-access file system for storing and accessing information available within the pod 1144. The QFS 1192 may support volume management capabilities, allowing many disks to be grouped together into a file system. The QFS 1192 may communicate with the database instances 1190, content search servers 1168 and/or indexers 1194 to identify, retrieve, move, and/or update data stored in the network file systems (NFS) 1196 and/or other storage systems.

In some implementations, one or more query servers 1182 may communicate with the NFS 1196 to retrieve and/or update information stored outside of the pod 1144. The NFS 1196 may allow servers located in the pod 1144 to access information over a network in a manner similar to how local storage is accessed. Queries from the query servers 1122 may be transmitted to the NFS 1196 via the load balancer 1128, which may distribute resource requests over various resources available in the on-demand database service environment 1100. The NFS 1196 may also communicate with the QFS 1192 to update the information stored on the NFS 1196 and/or to provide information to the QFS 1192 for use by servers located within the pod 1144.

In some implementations, the content batch servers 1164 may handle requests internal to the pod 1144. These requests may be long-running and/or not tied to a particular customer, such as requests related to log mining, cleanup work, and maintenance tasks. The content search servers 1168 may provide query and indexer functions such as functions allowing users to search through content stored in the on-demand database service environment 1100. The file servers 1186 may manage requests for information stored in the file storage 1198, which may store information such as documents, images, basic large objects (BLOBs), etc. The query servers 1182 may be used to retrieve information from one or more file systems. For example, the query system 1182 may receive requests for information from the app servers 1188 and then transmit information queries to the NFS 1196 located outside the pod 1144. The ACS servers 1180 may control access to data, hardware resources, or software resources called upon to render services provided by the pod 1144. The batch servers 1184 may process batch jobs, which are used to run tasks at specified times. Thus, the batch servers 1184 may transmit instructions to other servers, such as the app servers 1188, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

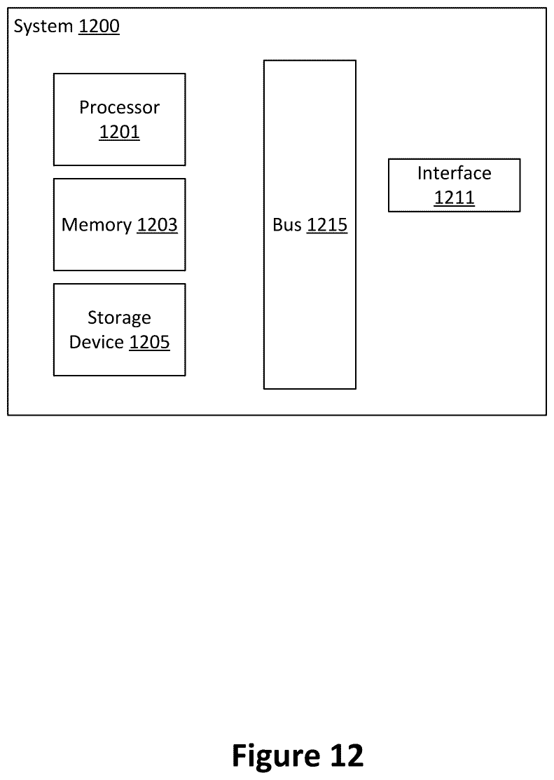

FIG. 12 illustrates one example of a computing device. According to various embodiments, a system 1200 suitable for implementing embodiments described herein includes a processor 1201, a memory module 1203, a storage device 1205, an interface 1211, and a bus 1215 (e.g., a PCI bus or other interconnection fabric.) System 1200 may operate as variety of devices such as an application server, a database server, or any other device or service described herein. Although a particular configuration is described, a variety of alternative configurations are possible. The processor 1201 may perform operations such as those described herein. Instructions for performing such operations may be embodied in the memory 1203, on one or more non-transitory computer readable media, or on some other storage device. Various specially configured devices can also be used in place of or in addition to the processor 1201. The interface 1211 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

FIG. 13 illustrates a method 1300 for processing multimodal input to an agent, configured in accordance with one or more embodiments. The method 1300 may be performed at the computing services environment 600 shown in FIG. 6.

A request to respond to user input provided in a user interaction via a conversational chat interface at 1302. A context for the user interaction is determined at 1304. According to various embodiments, as discussed herein, contextual information for a user interaction may include characteristics such as previously provided user input, previously performed computing services environment actions, previously generated textual responses, one or more topics, one or more actions performed, and/or other such information.

A determination is made at 1306 as to whether the user input includes non-textual input. According to various embodiments, non-textual input may include audio data, image data, video data, other types of non-textual data, or a combination thereof. Such information may be referenced in a file (e.g., via an upload process or a URL) or may be provided directly in the conversational chat interface.

Upon determining that non-textual input is present, an action to determine a summary of the non-textual input is triggered at 1308. In some embodiments, the type of action that is triggered may depend on the type of non-textual input. Further, some actions may be associated with flows that involve the triggering of different models and/or the performance of different processing operations.

In some embodiments, for example in the context of an image or video, a flow may include object recognition. For instance, an object recognition model may be executed. The object recognition model may produce a textual description of one or more objects represented in the image or video. For example, a user may provide a picture of a modem. The object recognition model may then analyze the picture to produce a description such as “A picture of a black modem. The modem is connected to a coaxial cable and an ethernet cable. One red light and one green light on the modem are illuminated.”

In some embodiments, for example in the context of an image or video, a flow may include text recognition. For instance, in the example of the user providing the picture of the modem, the text recognition model may be used to identify information such as a brand, a serial number, and a model number shown on the modem.

In some embodiments, for example in the context of a video or audio file, a speech-to-text model may be triggered. For instance, a user may provide a video of a modem along with associated audio. The audio may be translated as “My internet doesn't work. I think the modem is broken.”

In some embodiments, a flow may include one or more clarification operations. Such clarification operations may be directed to a user, to an agent, and/or to one or more actions or models executed by the agent. For example, in the example of a user providing the picture of the modem, the object recognition model may be instructed to generate a more detailed summary that characterizes the relative locations of the red and green lights. As another example, in the example of a user providing the picture of the modem, the user may be asked to provide an updated picture of the back of the model to better capture data such as the modem's serial number or model number.

A determination is made at 1310 as to whether to retrieve supplemental information for the user interaction. Upon determining that supplemental information is to be retrieved, the supplemental information for the user interaction is determined at 1312. In some embodiments, the determination may be made on the context and/or a summary determined at 1308. For instance, the user may provide textual input asking about a microwave error code and provide as input an image of a microwave displaying an error code. When the summary determined at 1308 includes a description of the microwave and the error code as converted to text, the agent may determine that a digital manual for the microwave should be consulted to determine the cause of the error code. Such information may be retrieved via a data retriever.

In some embodiments, a flow may include one or more retrieval-augmented generation actions. For example, a modem brand and serial number determined via a text recognition model may be used to identify a database record corresponding to the modem. As another example, natural language text determined based on one or more of natural language user input, text-to-speech model output, and/or image text recognition output may be analyzed by a generative language model to identify one or more search parameters for a search query transmitted via a search interface.

One or more actions are determined and performed at 1314. According to various embodiments, the type of action to be performed may depend on the context, the summary optionally determined at 1308, and/or the supplemental information optionally determined at 1312. Any of a variety of actions may be performed, depending on the context. For example, novel text providing an answer to a user's query may be generated. As another example, novel text requesting additional information, such as textual and/or non-textual user input, may be generated. As yet another example, one or more database records may be updated. As still another example, one or more operations such as scheduling a service appointment may be initiated. In some situations, multiple actions may be generated. For instance, a service appointment may be scheduled along with generating and providing a textual response to the user input.

A determination is made at 1316 as to whether additional user input has been received. In some embodiments, the determination at 1316 may wait for additional user input, for instance if a response including text requesting additional information has been sent to the user. Upon determining that additional user input has been received, a context for the user interaction is determined at 1304.

In some embodiments, information determined in the course of multi-modal input evaluation may be incorporated into an agent's context. For instance, a summary of multi-modal input may be included in a chat transcript evaluated by a generative language model to determine a response to a user and/or to determine another type of action.

In some embodiments, multi-modal input may be used to initiate a user interaction. For instance, a user may provide an image of a malfunctioning device in a chat interface. The autonomous agent acting as a conversational chat assistant may then analyze the image via multi-modal input analysis and generate novel text to inquire about the nature of the problem.

In some embodiments, multi-modal input may be used in the course of conducting an existing user interaction. For instance, in the course of a conversation between a user and an autonomous agent acting as a conversational chat assistant, the autonomous agent may generate novel text asking the user to provide an image or video of the malfunctioning device.

### Data Retrievers

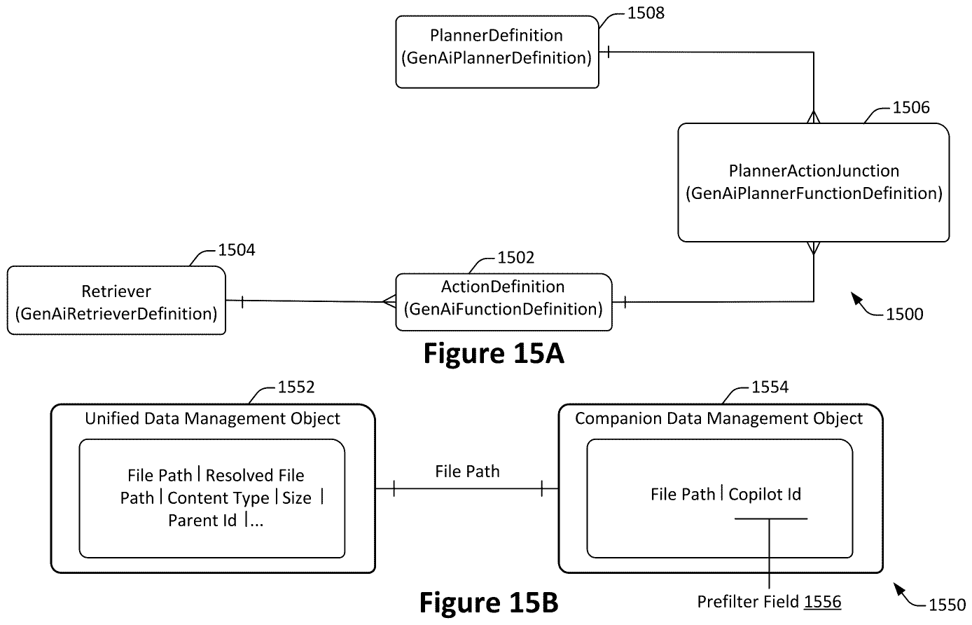

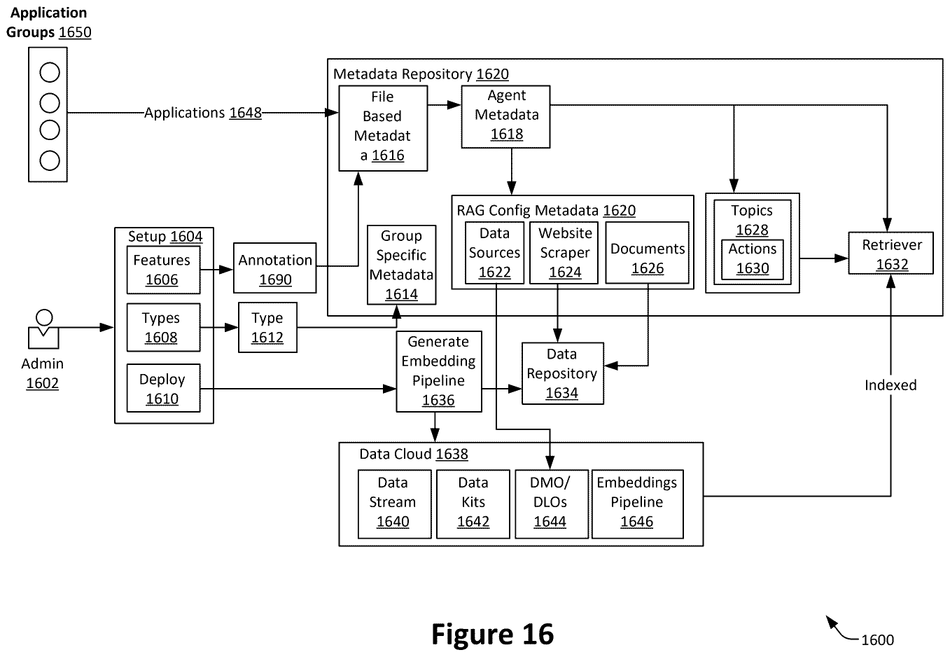

FIG. 14 illustrates an overview method 1400 for configuring real-time augmented generation (RAG) for autonomous agents, performed in accordance with one or more embodiments. The method 1400 may be performed at the computing services environment 200. A data model for providing data retrievers for retrieving data is provided in FIG. 15A, while architecture diagram for the configuration of RAG is provided in FIG. 16. Techniques and mechanisms described herein related to the configuration and execution of data retrievers (also referred to herein as data connectors) may be implemented in conjunction with the automated creation of an autonomous agent definition based on flowchart input information.

A request to configure information access for an agent is received at 1402. In some embodiments, the request may be received as part of the agent creation process. Alternatively, or additionally, data retrievers may be configured separately from agent retrieval. The request may be received via a user interface supporting agent configuration, such as the agent studio. Alternatively, the request may be received via an application procedure interface.

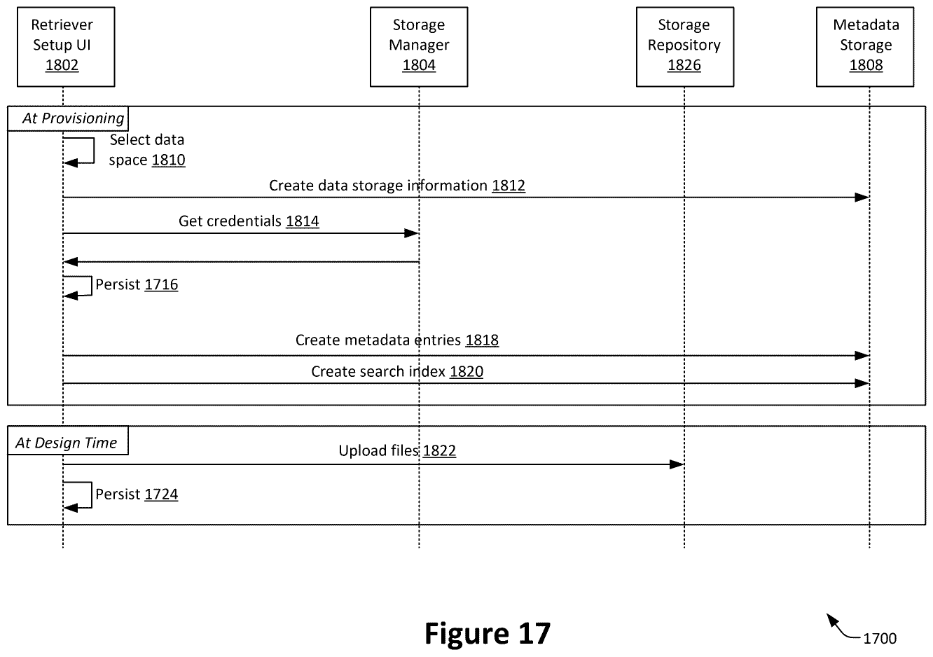

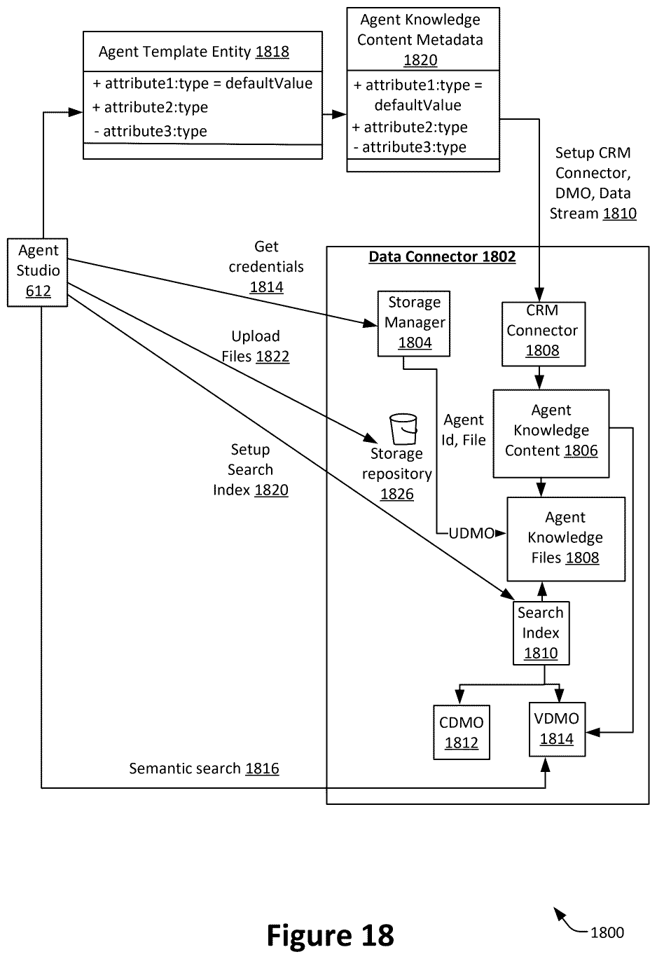

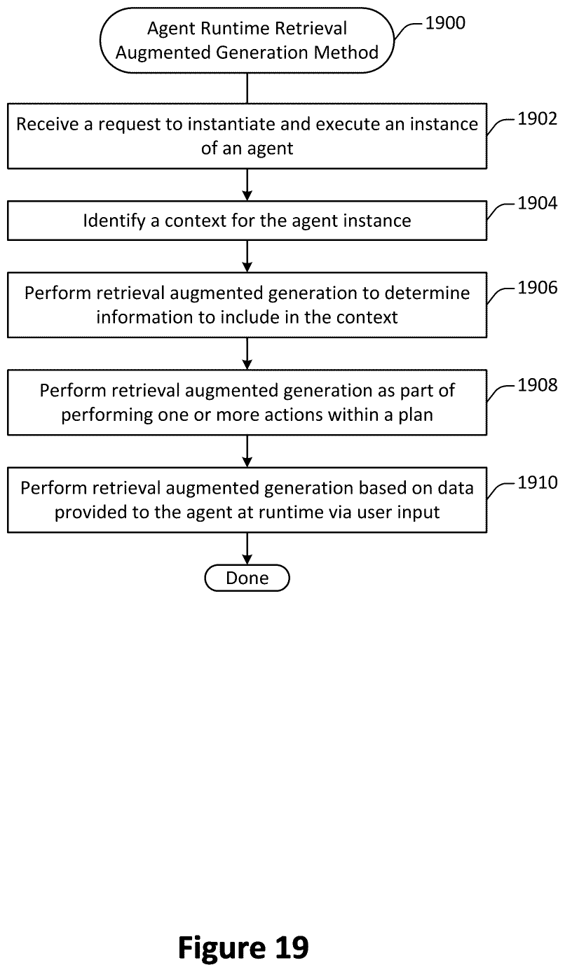

One or more unstructured data sources for the agent are determined at 1404. In some embodiments, unstructured data may include any of various file formats such as text-based formats (e.g., PDF, TXT, HTML, and plain text files), web content such as websites accessible through sitemaps, multimedia content such as images, audio, and video files, and/or any other unstructured content. Additional details for configuring a data retriever for unstructured data are discussed with respect to FIG. 17, FIG. 18, and FIG. 19.

One or more structured data sources for the agent are determined at 1406. According to various embodiments, structured data may include content organized within a relational database. Structured data may include, for instance, database records such as accounts and cases in a CRM database, custom data objects, and the like. Structured data may also include textual data stored in a structured manner, such as knowledge articles in a knowledge store. Additional details for configuring a data retriever for structured data are discussed with respect to FIG. 19.

One or more search connector data sources are configured for the agent at 1408. Search interfaces provide for open-ended knowledge retrieval based on search queries. Additional details for configuring a data retriever for a search interface are discussed with respect to FIG. 19.

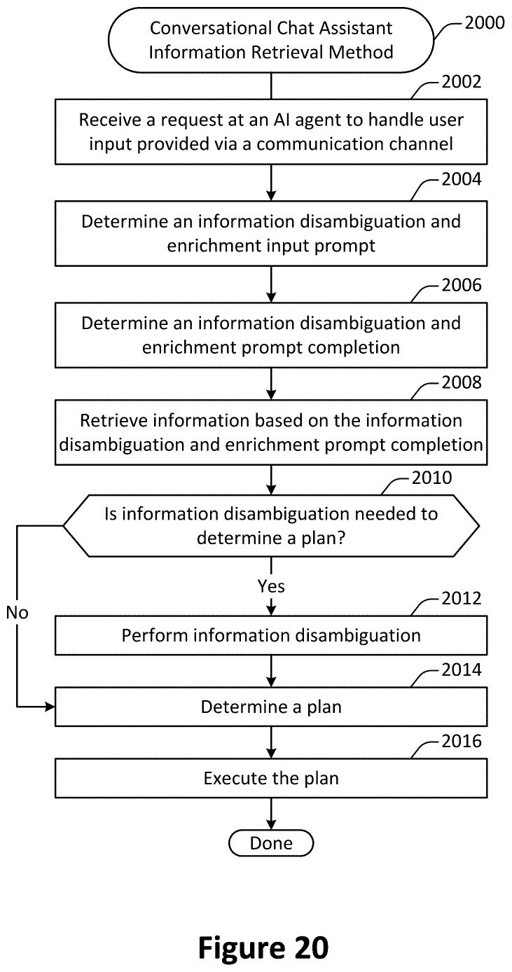

The sources are stored in association with the agent for runtime data retrieval at 1410. Additional details regarding runtime retrieval augmented generation are discussed with respect to the method 2000 shown in FIG. 20.

FIG. 15A illustrates a portion of an autonomous agent data retriever data model 1500, configured in accordance with one or more embodiments. According to various embodiments, a knowledge source for an agent may be represented as a retriever, which may be defined as an Agent Action type (i.e., Retriever) and associated with a Planner. The Retriever-side data model provides settings (e.g., for semantic search, citation, etc.) to enable RAG functionalities at the Agent level.

In FIG. 15A, an action definition 1502 may point to a retriever 1504 for retrieving data needed to execute the action. The same retriever may be employed by potentially many different action definitions. Similarly, the same action definition may employ many different retrievers. The action definition may also point to one or more planner action junctions 1506, which may provide a connection for a planner definition 1508 to access the action definition 1502. That is, the planner action junction 1506 may support a many-to-many relationship between planner definitions and action definitions.

FIG. 15B illustrates a data model diagram 1550 for providing access to unstructured data, configured in accordance with one or more embodiments. In some embodiments, unstructured data may be uploaded to a data lake or other file repository. Unstructured data may be represented and accessed via one or more pairs of unstructured data lake objects and unstructured data model objects configured at the organization level and accessible to agents and agent instances within that organization.

A unified data management object 1552 including information such as a file path, a resolved file path, a content type, a size, and more may be linked with a companion data management object 1554. The companion data management object 1554 may be used to link the unified data management object 1552 with a particular agent via a prefilter field 1556. The prefilter field 1556 provides for initial filtering to be applied to the data source before any data is returned.

FIG. 16 illustrates an architecture diagram 1600 for supporting RAG within an autonomous agent, configured in accordance with one or more embodiments. An administrator 1602 may interact with a setup interface 1604 to setup elements of an agent, including features 1606, types 1608, and deployments 1610.

In some embodiments, a retriever type 1612 may be specified within application group specific metadata 1614. Retrievers may be deployed at 1610, which may involve generating an embedding pipeline at 1636. The embedding pipeline 1646 may be represented in the data repository 1634.

In some implementations, features may be reflected in an annotation 1690 for the agent, which may be stored in a file-based metadata repository 1616. The annotation may be accessed by 1648 within the application groups 1650 to instantiate the agent.

In some embodiments, the agent may be represented based on agent metadata 1618 represented in the annotation 1690. The agent metadata 1618 may be reference the RAG configuration metadata 1620, one or more topics 1628 including one or more actions 1630 for the agent, and one or more retrievers 1632. A retriever 1632 may be a type of action 1630 and may be used to access indexed data from the data cloud 1638.

According to various embodiments, the data cloud 1638 may provide access to various types of data, including one or more data streams 1640, one or more data kits 1642, one or more data management objects (DMOs) and/or data lake objects (DLOs) 1644, and one or more embedding pipelines 1646.

FIG. 17 and FIG. 18 illustrate an architecture 1800 and associated process flow 1700 for configuring unstructured data, arranged in accordance with one or more embodiments. In particular the process flow 1700 illustrates a set of interactions between a user interface 1702 for setting up a retriever, a storage repository 1726 at which files are stored, a storage manager 1704 for managing the files, and a metadata repository 1708 for defining the data retriever. The architecture 1700 and process flow 1800 may be implemented at the computing services environment 200.

In some implementations, when a data retriever is provisioned, a data space for the agent may be selected at 1710 at the retriever setup UI 1702. The data space may define a location at which the data is to be stored. Data storage information is then created at 1708 based on communication between the retriever setup user interface and the metadata storage repository 1708. The data storage information may include information such as a companion BPO specifying a file path and agent identifier, a CRM connector, a data stream, and/or a DMO.

In some embodiments, temporary credentials are retrieved from the storage manager 1704 at 1714. The temporary credentials may also include information such as a storage location for the unstructured data. The credentials are persisted at 1716 at the retriever setup user interface 1702.

According to various embodiments, one or more metadata entries are created at 1718. Examples of the metadata entries that may be created include a UDLO and a DMO relationship. A search index is created at 1720.

In some embodiments, at design time, one or more files are uploaded at 1722 to the storage repository 1726. Metadata for those files is persisted at 1722. For instance, the metadata may be written to the BPO. The metadata may include information such as an agent identifier and a file path.

FIG. 18 provides an architectural overview that illustrates an alternative view of the operations shown in FIG. 17, organized around a data connector 1802. In the data connector, a CRM connector 1808 may provide access to agent knowledge content 1806, which may be implemented as one or more data manipulation language statements defining ways to insert, update, merge, delete, and/or restore data. To access the CRM connector 1808, an agent template entity 1718 may link to one or more agent knowledge content metadata entries 1720. The agent knowledge content 1806 may be used to access files via the agent knowledge files data manipulation language information 1808. The files may be indexed by the search index 1810, which may be accessed via the vector data module object (VDMO) 1814 and/or the data storage model object (DSMO) 1812. In particular, the VDMO 1814 may provide for semantic search 1816, for instance using the agent identifier as a prefilter.

Initially, a tenant (i.e. client) organization may be provisioned with a data object model a data object library at 1710 along with a search index at 1810. When files are uploaded, the agent authenticates a connection to file storage at 1726 and uploads the files at 1722. After uploading, the associated data entity may be marked with the information, after which the information is processed, vectorized, and used to create a search index. Then, a data retriever is configured at 1816, with the search index and a filter pointing to the content library, for retrieving the data. Newly uploaded files may be processed by marking the associated entity, which may be automatically synchronized with the data cloud 1802 to index the new files.

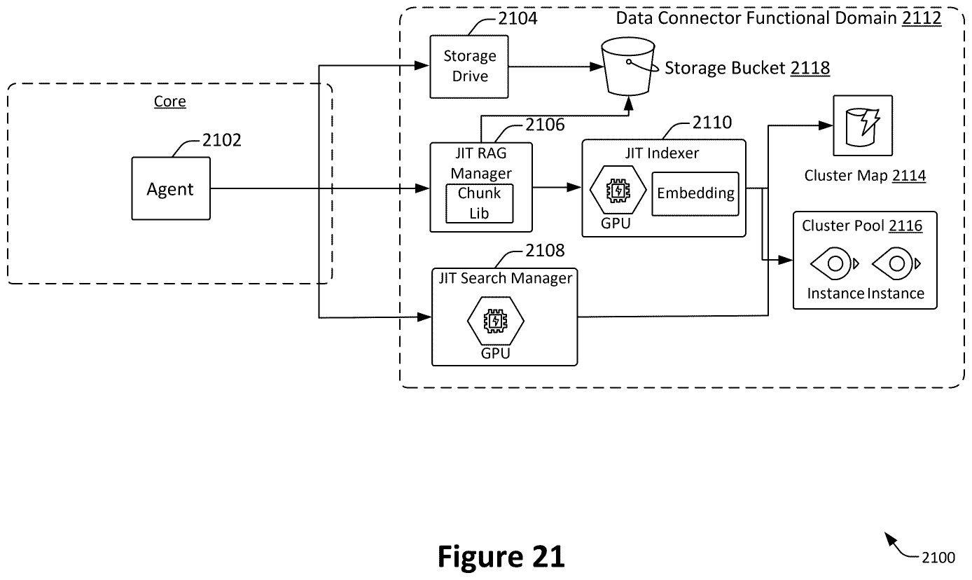

FIG. 19 illustrates a method 1900 for retrieval augmented generation at runtime in the context of a conversational chat assistant, performed in accordance with one or more embodiments. The method 1900 is described partially in reference to FIG. 21, which illustrates an architecture configuration 2100 supporting runtime retrieval augmented generation.

A request to in instantiate and execute an instance of an agent is received at 1902. A context for the agent instance is identified at 1904. In some embodiments, the performance of operations 1902 and 1904 may be completed as discussed with respect to the operations 3002 and 3004 shown in FIG. 30.

Retrieval-augmented generation is performed at 1906 to determine information to include in the agent's context. In some embodiments, agent RAG may be integrated into an agent at runtime as part of the prompt context. Such a configuration may provide additional information to a generative language model. To achieve this configuration, relevant data can be included in a prompt when the agent generates a response. For example, a user may ask specific product questions that may be addressed using a vector search. Some or all of the result of the vector search may then be included within the planner prompt for addressing the user's questions. Thus, prompt context RAG provides predetermined information for inclusion in a prompt and/or in other agent actions.

Such contextual information may be performed to retrieve information that may be available to an agent across potentially multiple actions. For instance, the information retrieved at 1906 may be included in a topic selection input prompt, a plan determination input prompt, an agent selection input prompt, a text generation prompt associated with the performance of an action, and/or any other action performed or prompt completed in association with the agent instance.

Retrieval augmented generation is performed at 1908 as part of performing one or more actions within a plan. In some embodiments, agent RAG may be integrated into an agent at runtime as part of an action within a topic. Such a configuration may enhance the agent's ability to access and process information dynamically. To achieve this configuration, the agent can invoke a RAG action to retrieve information during a conversation. For example, suppose that a user asks for the latest news about a company. In this situation, the agent can trigger a RAG action to search news articles and then incorporate the findings into its response. Thus, action-based RAG is a dynamic approach where information is retrieved on-demand during a conversation or other plan being executed by the agent.

Retrieval-augmented generation is performed at 1910 based on data provided to the agent at runtime via user input. In some embodiments, real-time RAG may support the uploading of documents by agent users and the querying of the documents' content through conversational interactions. In such a configuration, a chat session can serve as a container for the uploaded data. Just-In-Time (JIT) indexing may be used to rapidly process uploaded files and enable efficient semantic search. To enhance user experience, chat sessions can be resumed later, which involves persistent storage and retrieval of the indexed data.

In some embodiments, RAG at runtime may involve RAG based on input provided via a conversational chat interface. Additional details regarding such operations based on natural language user input are discussed with respect to the method 2000 shown in FIG. 20. As another example, in FIG. 21, an autonomous agent 2102 supports uploading files to a drive 2104.

In some embodiments, as shown in FIG. 21, the just-in-time RAG manager 2106 may support indexing of the files via the just-in-time indexer 2110. The indexed files may be stored in a storage location such as the storage bucket 2118 accessible via the storage drive 2104. The just-in-time search manager 2108 may support searching of the indexed information by the autonomous agent 2102. Such components may be located within a data connector functional domain 2112.

In some embodiments, the just-in-time indexer 2110 may produce an embedding, which may be used to support searching via a cluster map 2114 and/or a cluster pool 2114. For instance, the cluster pool 2114 may be a pool of Milvus instances.

According to various embodiments, any of the RAG operations discussed with respect to the method 1700 may involve the retrieval of structured and/or unstructured data. Data may be retrieved via a data retriever configured as discussed with respect to FIG. 14 through FIG. 19.

In some embodiments, ensemble RAG may combine different RAG models to enhance the overall performance and accuracy of a system, for instance when dealing with both structured and unstructured data. For example, different data retrievers may be used on specific data types (structured or unstructured) or domains. The system may then intelligently combine the outputs of these retrievers based on the nature of the query and the available RAG configuration. The outputs from different RAG models may be integrated to provide a comprehensive and informative response.

In some embodiments, a combination of a content library and a prompt template may be defined. In this way, retrievers from different content libraries may be used, with their outputs being combined via the corresponding prompt template. These pairings of action definitions and type input configuration may be stored in the metadata repository.

According to various embodiments, retrieval-augmented generation may be performed at various points in time within the agent lifecycle, and may be performed in various ways. For instance, RAG may be performed when an agent is configured, when an agent is instantiated, and/or when an action is performed. The particular timing of retrieval augmented generation for an agent may depend on factors such as the agent configuration and agent instance context. Thus, the method 1900 may be performed in conjunction with other methods described herein. For instance, one or more of the operations shown in FIG. 19 may be interleaved with the operations shown in other methods such as the method 3000. Additionally, one or more of the operations shown in FIG. 19 may be omitted, repeated, and/or performed in a different order than that shown.

FIG. 20 illustrates a method 2000 of retrieving information at a conversational chat assistant, performed in accordance with one or more embodiments. In some embodiments, the method 2000 may be performed at the computing services environment 200 shown in FIG. 2.

A request is received to handle, at an AI agent, user input provided via a communication channel. The operations shown in FIG. 20 provide an example of the types of operations that may performed within a specific AI agent configured as a conversational chat assistant.

An information disambiguation and enrichment input prompt is determined at 2004. In some embodiments, the information disambiguation and enrichment input prompt may include the user input received at 2002. The information disambiguation and enrichment input prompt may also include one or more natural language instructions to a generative language model to perform data enrichment and/or entity disambiguation. A non-exhaustive list of examples of such instructions are provided in the following paragraphs.

In some embodiments, the generative language model may be instructed to generate a query to identify one or more database types for database records mentioned in the user input. For example, the user input may include statements such as “Draft an email to the main contact for Acme”. In this example, the natural language instructions may instruct the generative language model to identify “Acme” in this text as a reference to an object stored in the database. However, the type of database object of which Acme is a member may be unclear. For instance, Acme may be an Opportunity object or an Account object. Thus, the natural language instructions may instruct the generative language model to construct a database query to search for various types of objects named “Acme.”

In some embodiments, the generative language model may be instructed to generate a query to identify one or more database records for database records mentioned in the user input. For example, the user input may include statements such as “What is the Acme opportunity worth?” In this example, the natural language instructions may instruct the generative language model to identify “Acme” in this text as a reference to an Opportunity object stored in the database. The natural language instructions may instruct the generative language model to construct a database query to search for an Opportunity object named Acme and return its value.

some embodiments, the generative language model may be instructed to generate a query to determine a query for retrieving data from one or more external sources. For example, the user input may include statements such as “Draft an email to the Acme contact that mentions the rising costs to companies of environmental changes such as global warming. Include statistics.” In this example, the natural language instructions may instruct the generative language model to identify statistics related to the rising costs to companies of environmental changes such as global warming as information that would need to be retrieved in order to draft the email. The natural language instructions may instruct the generative language model to determine one or more search queries to identify such information.

In some embodiments, the information disambiguation and enrichment input prompt may include natural language instructions executed by the generative language model to determine whether entity and/or record disambiguation is needed. For example, the information disambiguation and enrichment input prompt may include natural language instructions to indicate whether the determination of a plan depends on identifying an entity and/or a database record that is not clear from and/or included in the plan identification input prompt. As another example, the information disambiguation and enrichment input prompt may include natural language instructions to generate text for transmission to a client machine to elicit clarification regarding the identity of one or more entities and/or database records.

In some embodiments, the information disambiguation and enrichment input prompt may include natural language instructions executed by the generative language model to determine whether updated data is needed. For example, the information disambiguation and enrichment input prompt may include natural language instructions to indicate whether the determination of a plan depends on data that is not clear from and/or included in the information disambiguation and enrichment input prompt. As another example, the information disambiguation and enrichment input prompt may include natural language instructions to generate a search query, text to provide to a user, and/or other output for identifying the data that is needed.

According to various embodiments, a search query generated by the generative language model may be formulated for execution against an Internet search engine, a database, or another source of information. For instance, the search query may be executed against any data source accessible via a flow and vector search interface.

In some embodiments, a query determined as discussed with respect to operation 2006 may include one or more parameters limiting the query to a particular context. For example, a query may be limited to a tenant associated with a user account that provided the user input. As another example, a query may be limited to returning data objects to which the user account has permission to access. Any suitable limitations and preferences may be reflected in the query.

In some embodiments, the information disambiguation and enrichment input prompt determined at 2004 may be incorporated into a prompt for determining a topic or a plan. Alternatively, the information disambiguation and enrichment input prompt may be determined and completed separately.

An information disambiguation and enrichment prompt completion is determined at 2006. According to various embodiments, the determination of the information disambiguation prompt input prompt and the information disambiguation and enrichment prompt completion may be performed by combining the context with the user input and a template to create the input prompt, which may then be provided to a generative language model for completion.

Information is retrieved at 2008 based on the information disambiguation prompt completion. In some embodiments, the information may be retrieved by executing one or more queries determined by the generative language model in response to the information disambiguation input prompt. For example, as discussed with respect to operation 2004, the information disambiguation input prompt may include natural language instructions to determine queries to retrieve information from inside and/or outside of the database system. Such queries may then be extracted from the information disambiguation and enrichment prompt completion and used to retrieve the information at 2008.

In some embodiments, retrieving information may involve executing a database query. For instance, a query may be used to identify and retrieve information from one or more database records referenced in the user input. Alternatively, or additionally, retrieving information may involve accessing a data interface from retrieving information from another source, such as the Internet or a public or private data source residing outside of the database system.

A determination is made at 2010 as to whether information disambiguation is needed to determine a plan. In some embodiments, the determination may be made based on the information disambiguation and enrichment prompt completion determined at 2006. completion. For example, the information disambiguation and enrichment prompt completion may include one or more indicators as to whether information disambiguation is needed. The determination may be made based on the information retrieved at 2008.

In some embodiments, one or more database queries executed at 2008 may include an ambiguous result. For example, a database query executed against the database system may return both an Opportunity object and an Account object for Acme, rendering the user input ambiguous as to the user's intent. As another example, a database query executed against the database system may return two opportunity objects for Acme, an “Acme Inc.” and an “Acme Resources Ltd”, again rendering the user input ambiguous.

In some embodiments, one or more other data retrieval queries executed at 2008 may include an ambiguous result. For instance, an Internet search to retrieve information identifying “the capital of Georgia”, which is needed to draft a message based on user input, may reveal that “Georgia” may refer to a state in the United States or a country in Europe and Asia, again rendering the user input ambiguous and triggering the system to activate a process to resolve the ambiguity.

Upon determining that information disambiguation is needed, information disambiguation is performed at 2012. Disambiguating information may involve, for instance, dynamically identifying a particular type of database object being referred to.

Upon performing information disambiguation, or if no such disambiguation is needed, a plan is determined at 2014. According to various embodiments, the plan may include one or more actions to be performed within the computing services environment. The plan is then executed at 2016.

### Conclusion

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of JSON. However, the techniques of the present invention apply to a wide variety of formatting configurations. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A computing services environment including a hardware processor, the computing services environment comprising:
an agent creator configured to determine a plurality of metadata entries by analyzing flowchart description information via a generative language model, the flowchart description information being determined based on flowchart input information, the flowchart description information identifying in natural language (1) a plurality of nodes, (2) a plurality of directional linkages between the plurality of nodes, and (3) a plurality of textual characteristics of the plurality of nodes;
a database system storing autonomous agent definition information defining an autonomous agent and referencing the plurality of metadata entries, the plurality of metadata entries identifying a plurality of actions performed within the computing services environment and corresponding to the plurality of nodes, the plurality of actions including a data retrieval action;
an orchestration engine configured to instantiate an instance of the autonomous agent based on the autonomous agent definition information, the orchestration engine being configured to dynamically determine an execution plan identifying one or more the plurality of actions; and
an agent platform configured to execute the plurality of actions including retrieving data via the data retrieval action and updating information stored in the database system.

2. The computing services environment recited in claim 1, wherein the flowchart input information includes an image of a flowchart.

3. The computing services environment recited in claim 2, the agent creator being further configured to analyze the image of the flowchart via a multi-modal generative language model to determine the flowchart description information.

4. The computing services environment recited in claim 1, wherein an action of the plurality of actions corresponds to an outcome determination instruction to determine an outcome value based on input information via the generative language model.

5. The computing services environment recited in claim 4, wherein the plurality of metadata entries includes a first metadata entry associated with a first action and a second metadata entry associated with a second action, and wherein the autonomous agent definition information includes an action selection instruction to select the first action or the second action based on the outcome value.

6. The computing services environment recited in claim 1, wherein an action of the plurality of actions corresponds to an instruction to generate novel text via the generative language model.

7. The computing services environment recited in claim 1, wherein an action of the plurality of actions includes transmitting a message from the computing services environment to an external service, the message including natural language content generated by the generative language model.

8. The computing services environment recited in claim 1, wherein the agent creator is further configured to determine a data retrieval metadata entry corresponding to the data retrieval action, and wherein determining the data retrieval metadata entry includes identifying a data source and one or more parameter values to retrieve data via the data source.

9. The computing services environment recited in claim 8, wherein the data source is a database table in the database system, and wherein the one or more parameter values include one or more query parameters to retrieve one or more database records from the database system.

10. The computing services environment recited in claim 8, wherein the data source is associated with a unique address located outside of the computing services environment, and wherein the one or more parameter values include one or more authentication parameters to authenticate to the data source.

11. The computing services environment recited in claim 10, wherein the agent creator is further configured to autonomously identify the one or more authentication parameters based on database account information associated with a database account, the flowchart input information being received from a client machine authenticated to the database account.

12. A method implemented in a computing services environment including a hardware processor and a database system, the method comprising:
determining a plurality of metadata entries by analyzing flowchart description information via a generative language model, the flowchart description information being determined based on flowchart input information, the flowchart description information identifying in natural language (1) a plurality of nodes, (2) a plurality of directional linkages between the plurality of nodes, and (3) a plurality of textual characteristics of the plurality of nodes;
storing autonomous agent definition information defining an autonomous agent and referencing the plurality of metadata entries in the database system, the plurality of metadata entries identifying a plurality of actions performed within the computing services environment and corresponding to the plurality of nodes, the plurality of actions including a data retrieval action;
instantiate an instance of the autonomous agent in an orchestration engine based on the autonomous agent definition information, the orchestration engine being configured to dynamically determine an execution plan identifying one or more the plurality of actions; and
executing the plurality of actions including retrieving data via the data retrieval action and updating information stored in the database system.

13. The method recited in claim 12, wherein the flowchart input information includes an image of a flowchart, the method further comprising analyzing the image of the flowchart via a multi-modal generative language model to determine the flowchart description information.

14. The method recited in claim 12, wherein an action of the plurality of actions corresponds to an outcome determination instruction to determine an outcome value based on input information via the generative language model, wherein the plurality of metadata entries includes a first metadata entry associated with a first action and a second metadata entry associated with a second action, and wherein the autonomous agent definition information includes an action selection instruction to select the first action or the second action based on the outcome value.

15. The method recited in claim 12, wherein an action of the plurality of actions includes transmitting a message from the computing services environment to an external service, the message including natural language content generated by the generative language model.

16. The method recited in claim 12, the method further comprising:
determining a data retrieval metadata entry corresponding to the data retrieval action, and wherein determining the data retrieval metadata entry includes identifying a data source and one or more parameter values to retrieve data via the data source, wherein the data source is a database table in the database system, and wherein the one or more parameter values include one or more query parameters to retrieve one or more database records from the database system.

17. The method recited in claim 12, the method further comprising:
determine a data retrieval metadata entry corresponding to the data retrieval action, and wherein determining the data retrieval metadata entry includes identifying a data source and one or more parameter values to retrieve data via the data source, wherein the data source is associated with a unique address located outside of the computing services environment, and wherein the one or more parameter values include one or more authentication parameters to authenticate to the data source.

18. One or more non-transitory computer readable media having instructions stored thereon for performing a method implemented in a computing services environment including a hardware processor and a database system, the method comprising:
determining a plurality of metadata entries by analyzing flowchart description information via a generative language model, the flowchart description information being determined based on flowchart input information, the flowchart description information identifying in natural language (1) a plurality of nodes, (2) a plurality of directional linkages between the plurality of nodes, and (3) a plurality of textual characteristics of the plurality of nodes;
storing autonomous agent definition information defining an autonomous agent and referencing the plurality of metadata entries in the database system, the plurality of metadata entries identifying a plurality of actions performed within the computing services environment and corresponding to the plurality of nodes, the plurality of actions including a data retrieval action;
instantiate an instance of the autonomous agent in an orchestration engine based on the autonomous agent definition information, the orchestration engine being configured to dynamically determine an execution plan identifying one or more the plurality of actions; and
executing the plurality of actions including retrieving data via the data retrieval action and updating information stored in the database system.

19. The one or more non-transitory computer readable media recited in claim 18, wherein the flowchart input information includes an image of a flowchart, the method further comprising:
analyzing the image of the flowchart via a multi-modal generative language model to determine the flowchart description information.

20. The one or more non-transitory computer readable media recited in claim 18, wherein an action of the plurality of actions corresponds to an outcome determination instruction to determine an outcome value based on input information via the generative language model, wherein the plurality of metadata entries includes a first metadata entry associated with a first action and a second metadata entry associated with a second action, and wherein the autonomous agent definition information includes an action selection instruction to select the first action or the second action based on the outcome value.
